(19) United States
(12) Patent Application Publication
(10) Pub. No.: US 2020/0265347 A1
(43) Pub. Date: Aug. 20, 2020

(54) ALLOCATION METHOD, STORAGE MEDIUM, AND INFORMATION PROCESSING DEVICE

(71) Applicant: FUJITSU LIMITED, Kawasaki-shi (JP)

(72) Inventors: Kensuke Baba, Fukuoka (JP); Shigeki FUKUTA, Setagaya (JP); Tomoya Noro, Yokohama (JP); Seiji Okura, Setagaya (JP); Takao MOHRI, Kawasaki (JP)

(73) Assignee: FUJITSU LIMITED, Kawasaki-shi (JP)

(21) Appl. No.: 16/790,834

(22) Filed: Feb. 14, 2020

(30) Foreign Application Priority Data
Feb. 18, 2019 (JP) 2019-026952

(51) Int. Cl. G06Q 10/02; G06Q 10/06; G06Q 10/10; G06F 16/2457

(52) U.S. Cl. CPC G06Q 10/02; G06Q 10/06312; G06F 16/24578; G06Q 10/1095; G06Q 10/0637

(57) ABSTRACT

An allocation method executed by a computer, the allocation method includes receiving a demand for allocating a predetermined event to one of a plurality of frames; setting a weight for a free space in each of a plurality of candidates based on usage frequency of one or more candidates corresponding to the demand for allocating the predetermined event by referring to information on usage frequency of each of a plurality of frames in the past; identifying, from among the plurality of candidates, a candidate whose space is smaller than another space when allocating the predetermined event to the candidate based on the free space in each of the plurality of candidates and the weight for the free space; and outputting the identified candidate.

### CROSS-REFERENCE TO RELATED APPLICATION

This application is based upon and claims the benefit of priority of the prior Japanese Patent Application No. 2019-26952, filed on Feb. 18, 2019, the entire contents of which are incorporated herein by reference.

### FIELD

The embodiments discussed herein are related to an allocation method, a storage medium, and an information processing device.

### BACKGROUND

There is a technique for allocating an event to one of multiple frames in response to an allocation demand. For example, there is a technique for allocating a meeting plan in response to an allocation demand to an unoccupied time period to which no meeting plan is allocated yet within an available time frame of one of multiple conference rooms satisfying a condition included in the allocation demand.

As a related art, for example, there is a technique for receiving, as a booking condition from a user, a condition that is a time period request of service instead of the name of a vehicle for boarding. Additionally, for example, there is a technique in which when a customer tries to make a seat reservation by designating the position of a desired seat in a facility such but the desired seat is unavailable, a seat reservation system generates a searching condition for searching for an alternative seat and presents the condition to the customer who is going to make the reservation. Moreover, for example, there is a technique for reallocating a rental product based on new reservation information, already-accepted reservation information, and a rental product information and determining whether it is possible to accept the new reservation based, on the reallocation result. Related techniques are disclosed in, for example, Japanese Laid-open Patent Publication Nos. 2002-312440, 2001-357273, and 2001-351028.

### SUMMARY

According to an aspect' of the embodiments, an allocation method executed by a computer, the allocation method includes receiving a demand for allocating a predetermined event to one of a plurality of frames; setting a weight for a free space in each of a plurality of candidates based on usage frequency of one or more candidates corresponding to the demand for allocating the predetermined event by referring to information on usage frequency of each of a plurality of frames in the past; identifying, from among the plurality of candidates, a candidate whose space is smaller than another space when allocating the predetermined event to the candidate based on the free space in each of the plurality of candidates and the weight for the free space; and outputting the identified candidate.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an allocation method according to an embodiment;

FIG. 2 is an explanatory diagram illustrating an example of an allocation system;

FIG. 3 is a block diagram illustrating hardware configuration example of an information processing device;

FIG. 4 is an explanatory diagram illustrating an example of the contents stored in a plan DB;

FIG. 5 is an explanatory diagram illustrating an example of the contents stored in a request frequency DB;

FIG. 6 is an explanatory diagram illustrating an example of the contents stored in a slot DB;

FIG. 7 is a block diagram illustrating a hardware configuration example of a terminal device;

FIG. 8 is a block diagram illustrating a functional configuration example of the information processing device;

FIG. 9 is a block diagram illustrating a specific example of the functional configuration of the information processing device;

FIG. 10 is an explanatory diagram illustrating an online algorithm for the bin packing problem;

FIG. 11 is an explanatory diagram illustrating an example of allocating a meeting plan to one of multiple slots;

FIG. 12 is an explanatory diagram illustrating an example of dividing a slot into parts;

FIG. 13 is an explanatory diagram (part 1) illustrating an example of a screen implementing a chatbot;

FIG. 14 is an explanatory diagram (part 2) illustrating the example of the screen implementing the chatbot;

FIG. 15 is an explanatory diagram (part 3) illustrating the example of the screen implementing the chatbot;

FIG. 16 is an explanatory diagram (part 1) illustrating another example of the conversation with a user in the chatbot;

FIG. 17 is an explanatory diagram (part 2) illustrating another example of the conversation with the user in the chatbot;

FIG. 18 is a flowchart (part 1) illustrating an example of an update processing procedure;

FIG. 19 is a flowchart (part 2) illustrating an example of the update processing procedure; and

FIG. 20 is a flowchart illustrating an example of an allocation processing procedure.

### DESCRIPTION OF EMBODIMENTS

However, in the related art, there may be the case where it is impossible to allocate an event to any frame. For example, when there are multiple frames satisfying a condition for allocating an event, it is difficult to determine what is the best allocation that makes it most likely to avoid a situation where a subsequent attempt to allocate another event to one of the frames results in a failure in allocating the event to any of the frames. In view of the above, it is desirable to suppress the occurrence of the situation where it is impossible to allocate an event to any frame.

Hereinafter, embodiments of an allocation method, an allocation program, and an information processing device according to the present disclosure are described in detail with reference to the drawings.

(Example of Allocation Method according to Embodiment)

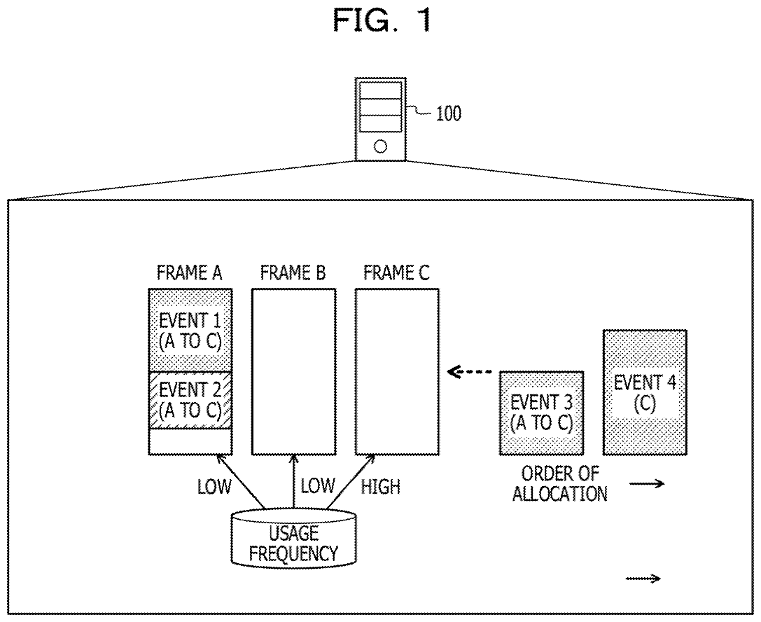

FIG. 1 is an explanatory diagram illustrating an example of an allocation method according to the embodiment. An information processing device 100 is a computer that allocates an event to one of multiple frames. The event is, for example, a plan to use a conference room. The frame is, for example, an available time frame of the conference room that is set in association with the conference room to be a target for allocating the plan to use the conference room thereto.

There is already a technique for allocating each of various events to one of multiple frames such that the event is allocated to a frame that has the smallest free space to which no event is allocated, among one or more frames satisfying an event allocation condition. This technology is an online algorithm for the bin packing problem, for example.

However, there may be caused an increase in the possibility that it impossible to allocate an event to any of the multiple frames during the processes of allocating each of the various events to one of the frames. For example, when there are multiple frames satisfying a condition for allocating an event, it is difficult to determine what is the best allocation that makes it most likely to avoid a situation where a subsequent attempt to allocate another event to one of the frames results in a failure in allocating the event to any of the frames.

Specifically, even when it is possible to allocate a new meeting plan to a time frame of a conference room having a relatively low user request frequency, there may be the case where the new meeting plan is allocated to a time frame of a conference room having a relatively high user request frequency, for example. The request frequency is an index value indicating the number of times the user requests the allocation of a meeting plan, for example. Specifically, the request frequency is set based on the number of times the condition for allocating the meeting plan designated by the user is satisfied, for example. In this case, there is caused a reduction of a free space in a time frame of the conference room estimated to have a high possibility that the allocation of another event thereto will be requested subsequently, and the possibility that it is impossible to allocate the other meeting plan subsequently is increased.

To deal with this, for the case where it is impossible to allocate a new meeting plan to any of the time frames of the conference rooms, there is thought a method of changing the meeting plan already allocated to one of the time frames of the conference rooms and creating a free space. This method makes it possible to allocate the new meeting plan to the free space created in one of the time frames of the conference room.

However, this method may make a negotiation between users involved with the meeting to change the meeting plan, and this increases the work burden on the users. Additionally, since the users involved with the meeting have to be notified with the change of the meeting plan, the work burden on the users is increased, and also an inconvenience may be caused by miscommunication. As described above, this method requires complicated procedures and is likely to cause the increase of the work burden on the users.

In view of this, in this embodiment, there is described an allocation method for allocating a predetermined event to one of multiple frames, which enables specification of a candidate for the frame where to allocate the predetermined event, so as to reduce the possibility that it is impossible to allocate another event subsequently to any of the frames.

In FIG. 1, the information processing device 100 stores information on the usage frequency of each frame in the past. The usage frequency is, for example, a frequency that a frame is identified as a candidate for an allocation space based on an allocation demand in the past. In the example of FIG. 1, there are a frame A, a frame B, and a frame C. In the example of FIG. 1, the information processing device 100 stores information on the usage frequencies of the frames A, B, and C in the past. In the example of FIG. 1, the usage frequency of the frame C is higher than the usage frequency of the frame A and the usage frequency of the frame B.

The information processing device 100 receives a demand for allocation of a predetermined event to one of the frames. For example, the demand includes information specifying the candidate for the frame to be the allocation space where to allocate a predetermined event. Next, the information processing device 100 identifies one or more candidates for the frame to be the allocation space based on the information, which is included in the demand and specifies the candidate for the frame to be the allocation space where to allocate the predetermined event.

The information processing device 100 refers to the information on the usage frequency of each frame in the past and sets a weight for a free space in each of the one or more identified candidates based on the usage frequency of each candidate. Next, the information processing device 100 identifies as the allocation space a candidate that has a relatively small free space among the one or more candidates after the allocation of the predetermined event based on the free space in each candidate and the weight for the free space, and outputs the identified candidate. “Relatively small” means, for example, “smaller than the other at least”, or means, for example, “the smallest” when there are multiple candidates to be identified. “Relatively small” means, for example, “the smallest” when there is one candidate to be identified.

The weight is, for example, a correction factor that corrects the size of the free space. The free space is corrected to be greater as the weight is greater. Consequently, in the case of identifying as the allocation space a candidate that has a relatively small free space after the allocation of the predetermined event, a frame having a free space for which the greater weight is set is less likely to be identified as the allocation space.

In the example of FIG. 1, (1-1) the information processing device 100 includes information identifying the frames A, B, and C as candidates for the frame to be the allocation space for an event 1 and receives an allocation demand for demanding the allocation of the event 1. The information processing device 100 identifies the frames A, B, and C, which are identified as the candidates for the frame to be the allocation space for the event 1 based on the information included in the allocation demand and which each have the free space to which the event 1 is able to be allocated.

Based on the usage frequency of each of the identified frames A, B, and C, the information processing device 100 sets the weight for the free space of each of the frames A, B, and C such that the weight for the free space is greater as the usage frequency is higher. Since the usage frequency of the frame C is higher than the usage frequency of the frame A and the usage frequency of the frame B, the information processing device 100 sets the weight for the free space of the frame C greater than the weight for the free space of the frame A and the weight for the free space of the frame B.

The information processing device 100 corrects the size of the free space of each of the frames A, B, and C using the weight set for the free space. Among the frames A, B, and C identified as the candidates for the frame to be the allocation space for the event 1, the information processing device 100 identifies a frame that has the smallest free space after the allocation of the event 1 as the allocation space for the event 1, and outputs the identified frame. The information processing device 100 identifies and outputs the frame A as the allocation space for the event 1.

According to the above, the information processing device 100 is able to make the event 1 more likely to be allocated to the frame A or the frame B than the frame C. Additionally, the information processing device 100 is able to preserve the free space in the frame C estimated to have the relatively high possibility that the allocation of another event thereto will be requested subsequently, so as to allow the allocation of the other event thereto.

(1-2) The information processing device 100 includes information identifying the frames A, B, and C as candidates for the frame as the allocation space for an event 2 and receives an allocation demand for demanding the allocation of the event 2. Like (1-1), the information processing device 100 identifies the frames A, B, and C, which are identified as the candidates for the frame to be the allocation space for the event 2 based on the information included in the allocation demand and which each have the free space to which the event 2 is able to be allocated, identifies the frame A as the allocation space for the event 2, and outputs the identified frame A.

According to the above, the information processing device 100 is able to make the event 2 more likely to be allocated to the frame A or the frame B than the frame C. Additionally, the information processing device 100 is able to preserve the free space in the frame C estimated to have the relatively high possibility that the allocation of another event thereto will be requested subsequently, so as to allow the allocation of the other event thereto.

(1-3) The information processing device 100 includes information identifying the frames A, B, and C as candidates for the frame as the allocation space for an event 3 and receives an allocation demand for demanding the allocation of the event Like (1-1), the information processing device 100 identifies the frames B and C, which are identified as the candidates for the frame to be the allocation space for the event 3 based on the information included in the allocation demand and which each have the free space to which the event 3 is able to be allocated, identifies the frame B as the allocation space for the event 3, and outputs the identified frame B.

According to the above, the information processing device 100 is able to make the event 3 more likely to be allocated to the frame B than the frame C. Additionally, the information processing device 100 is able to preserve the free space in the frame C estimated to have the relatively high possibility that the allocation of another event thereto will be requested subsequently, so as to allow the allocation of the other event thereto.

(1-4) the information processing device 100 includes information identifying the frame C as a candidate for the frame as the allocation space for an event 4 and receives an allocation demand for demanding the allocation of the event 4. The information processing device 100 identifies the frame C, which is identified as the candidate for the frame to be the allocation space for the event 4 based on the information included in the allocation demand and which has the free space to which the event 4 is able to be allocated.

Based on the usage frequency of the identified frame C, the information processing device 100 sets the weight for the free space of the frame C such that the weight for the free space is greater as the usage frequency is higher. The information processing device 100 corrects the size of the free space of the frame C using the weight set for the free space. The information processing device 100 identifies as the allocation space for the event 4 a frame that has the smallest free space among the candidates for the frame to be the allocation space for the event 4 after the allocation of the event 4, and outputs the identified frame. The information processing device 100 identifies and outputs the frame C as the allocation space for the event 4.

According to the above, since the information processing device 100 does not allocate the events 1, 2, and 3 to the frame C and preserves the free space in the frame C, it is possible to allocate the event 4 to the frame C.

Thus, the information processing device 100 is able to reduce the possibility that it is impossible to allocate an event to any of the multiple frames during the processes of allocating each of various events to one of the frames. Accordingly, the information processing device 100 is able to suppress the occurrence of the situation where it is impossible to allocate an event to any frames. Consequently, the information processing device 100 is able to increase the number of events to be eventually allocated in all the multiple frames and able to use all the multiple frames efficiently.

For example, there may be the case where an event is allocated to one of the multiple frames manually by the user. In this case, when a user a manually allocates events such as the events 1 and 2 to the frame C and thereafter α user β tries to allocate the event 4 to the frame C, it may be impossible to allocate the event 4 to the frame C because the free space in the frame C is small.

This may cause the user 13 to negotiate with the user α for a change of the allocation spaces for the events 1 and 2, and the work burden on the users α and β may be both increased. Alternatively, the user β may give up the allocation of the event 4 to the frame C, and an inconvenience to the works of the user β may be caused.

Additionally, for example, there may be the case where an event is allocated by identifying as the allocation space for the event a frame that has the smallest free space after the allocation of the event without setting the weight for the free space. Since the free space in the frame C becomes small when the event 1 is allocated to the frame C first, the possibility that the following event 2 is allocated to the frame C is accordingly increased, and the free space in the frame C becomes smaller. Since the free space in the frame C is small, it may be impossible to allocate the event 4 subsequently even if the event 4 is tried to be allocated to the frame C.

This may cause a negotiation between a user involved with the event such as the events 1 and 2 and a user involved with the event 4 for changing the allocation space, and the work burden on the users may be increased. Alternatively, the user involved with the event 4 may give up the allocation of the event 4 and an inconvenience to the works of the user involved with the event 4 may be caused.

In contrast, the information processing device 100 is able to preserve the free space in the frame estimated to have the relatively high possibility that the allocation of another event thereto will be requested subsequently, so as to allow the subsequent allocation of the other event thereto, every time an event is allocated to one of the frames. Consequently, when a new event is to be allocated to one of the frames, the information processing device 100 is able to increase the possibility of avoiding the change of the allocation space for an event already allocated to the frame, and thus it is possible to reduce the work burden on the user.

For example, the information processing device 100 is able to make an event such as the events 1 and 2 more likely to be allocated to the frame A or the frame B than, the frame C and able to preserve the free space in the frame C by not allocating the event such as the events 1 and 2 to the free space in the frame C. Accordingly, when the event 4 is to be allocated, the information processing device 100 is able to allocate the event 4 to the frame C. Consequently, the information processing device 100 is able to avoid the negotiation between the user involved with the event such as the events 1 and 2 and the user involved with the event 4 for changing the allocation space, and thus it is possible to reduce the work burden on the user.

The case where the information processing device 100 sets the weight for the free space in each of the one or more candidates for the frame to be the allocation space for an event every time the allocation demand of the event is received is described herein; however, the embodiment is not limited thereto. For example, there may be the case where the information processing device 100 sets the weight for the free space in each of the multiple frames in predetermined timing and uses the set weight when receiving the allocation demand of an event after the predetermined timing.

The case where the information processing device 100 sets the weight for the free space in the candidate for the frame to be the allocation space for an event even when there is only one identified candidate for the frame to be the allocation space for the event is described herein; however, the embodiment is not limited thereto. For example, there may be the case where the information processing device 100 omits the setting of the weight for the free space in the candidate for the frame to be the allocation space for the event when there is only one identified candidate for the frame to be the allocation space for the event. In this case, since there is no comparison target of the free space in the identified candidate for the frame to be, the allocation space for the event, the information processing device 100 identifies as the allocation space the identified candidate for the frame to be the allocation space for the event.

(Example of Allocation System 200)

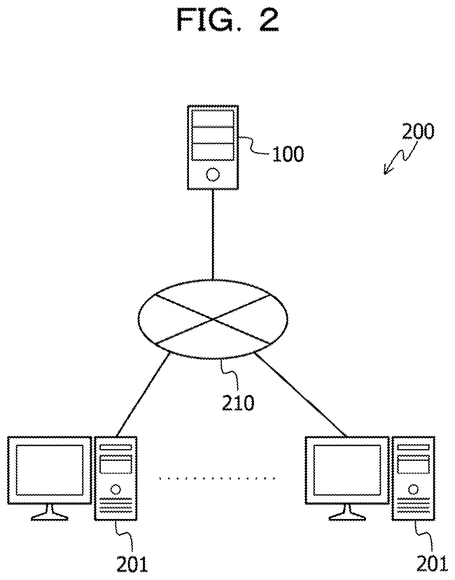

Next, an example of an allocation system 200 to which the information processing device 100 illustrated in FIG. 1 is applied is described with reference to FIG. 2.

FIG. 2 is an explanatory diagram illustrating an example of the allocation system 200. In FIG. 2, the allocation system 200 includes the information processing device 100 and a terminal device 201. In the allocation system 200, the information processing device 100 and the terminal device 201 are coupled with each other through a wired or wireless network 210. The network 210 is, for example, a local area network (LAN), a wide area network (WAN), the Internet, or the like.

The information processing device 100 receives the allocation demand for demanding the allocation of an event to one of the multiple frames from the terminal device 201. In response to the allocation demand, the information processing device 100 identifies one of the multiple frames that is to be the allocation space for the event demanded to be allocated, and outputs the identified frame to the terminal device 201. Once receiving an allocation instruction from the terminal device 201, the information processing device 00 allocates the event demanded to be allocated to the identified frame. The information processing device 100 is, for example, a server, a personal computer (PC) or the like.

The terminal device 201 is a computer used by the user involved with the event. The user involved with the event may be, for example, a user managing the event allocations. Based on the operational input by the user, the terminal device 201 generates the allocation demand including the information specifying the candidate for the frame where to allocate the event, and transmits the generated allocation demand to the information processing device 100. The terminal device 201 receives the frame to be the allocation space for the event from the information processing device 100, and displays the received frame. Based on the operational input by the user, the terminal device 201 transmits the allocation instruction for instructing the allocation of the event to the received frame to be the allocation space for the event to the information processing device 100. The terminal device 201 is, for example, a PC, a tablet terminal, a smartphone, or the like.

(Specific Example of Allocation System 200 (Part 1))

Next, a specific example of the allocation system 200 (part 1) is described. For example, as the specific example of the allocation system 200 (part 1), there may be considered a specific example of the case where the event is a plan to use a conference room, and the frame is an available time frame of the conference room, which is set in association with the conference room so as to allocate the plan to use the conference room thereto. The plan, to use the conference room is, for example, a meeting.

In this case, the information processing device 100 is able to make a free space likely to be preserved, the free space being in a time frame of a conference room estimated to have the relatively high possibility that the allocation of another plan thereto will be requested subsequently, every time a plan is allocated to one of the time frames of the conference rooms. Consequently, the information processing device 100 is able to increase the possibility of avoiding the change of the allocation space for a plan already allocated to one of the time frames of the conference rooms, and thus it is possible to reduce the work burden on the user.

For example, it may be considered that the request frequencies of requesting the allocation of a plan to the time frame of a conference room are uneven among the conference rooms depending on the facilities of the conference rooms and the capacity of the conference rooms. Specifically, the time frame of a versatile conference run, such as a conference room having many facilities or a conference room having a large capacity, tends to have the higher request frequency, for example.

In contrast, the information processing device 100 is able to make the free space likely to be preserved by not allocating a plan to the time frame of the versatile conference room having the high request frequency. Accordingly, the information processing device 100 is able to reduce the possibility of failing to allocate a plan when the plan is able to be conducted in only the conference room having the high request frequency. Consequently, the information processing device 100 is able to improve the efficiency of the works of all the users involved with each of the various plans.

(Specific Example of Allocation System 200 (Part 2))

Next, a specific example of the allocation system 200 (part 2) is described. For example, as the specific example of the allocation system 200 (part 2), there may be considered a specific example of the case where the event is a plan of object rental, and the frame is a time frame in which the rental of the object is usable, which is set in association with the object so as to allocate the plan of object rental thereto. The object is for example, a vehicle a work item, or the like.

In this case, in response to the allocation demand, the information processing device 100 identifies a time frame of one of the multiple objects as the allocation space for the plan demanded to be allocated, and transmits the identified time frame to the terminal device 201. The terminal device 201 receives the time frame of the object as the allocation space for the plan from the information processing device 100, and displays the received time frame. Thereafter, once receiving the allocation instruction from the terminal device 201, the information processing device 100 allocates the plan demanded to be allocated to the identified time frame of the object.

In this case, the information processing device 100 is able to make a free space likely to be preserved, the free space being in a time frame of the object estimated to have the relatively high possibility that the allocation of another plan thereto will be demanded subsequently, every time a plan is allocated to one of the time frames of the objects. Consequently, the information processing device 100 is able to increase the possibility of avoiding the change of the allocation space for a plan already allocated to one of the time frames of the objects.

(Specific Example of Allocation System 200 (Part 3))

Next, a specific example of the allocation system 200 (part 3) is described. For example, as the specific example of the allocation system 200 (part 3), there may be considered a specific example of the case where the event is a plan of providing a customer with a service, and the frame is a time frame in which an employee is able to work on the service. For example, the time frame is set in association with the employee providing the service so as to allocate the plan of providing the customer with the service thereto. The service is, for example, beauty treatment, haircut, or the like.

In this case, the information processing device 100 s able to make a free spate likely to be preserved, the free space being in a time frame of the employee estimated to have the relatively high possibility that the allocation of another plan thereto will be demanded subsequently, every time a plan is allocated to one of the time frames of the employees. Consequently, the information processing device 100 is able to increase the possibility of avoiding the change of the allocation space of a plan already allocated to one of the time frames of the employees.

For example, it may be considered that the request frequencies of requesting the allocation of a plan to the time frame of the employee are uneven among the employees depending on the attributes and the skills of the employees. Specifically, the time frame of an employee having an acclaimed skill and being versatile and popular tends to have the higher request frequency.

In contrast, the information processing device 100 is able to make the free space likely to be preserved by not allocating a plan to the time frame of the versatile and popular employee having the high request frequency. Accordingly, the information processing device 100 is able to reduce the, possibility of failing to allocate a plan when the plan is able to be provided by only the employee having the high request frequency. Consequently, the information processing device 100 is able to improve the satisfaction with the service of all the customers involved with each of the various plans.

(Specific Example of Allocation System 200 (Part 4))

Next, a specific example of the allocation system 200 (part 4) is described. For example, as the specific example of the allocation system 200 (part 4), there may be considered a specific example of the case where the event is a plan to use a partial area of a predetermined place, and the frame is the entire area of the predetermined place, which is set in association with the predetermined place so as to allocate the plan thereto. The place is, for example, a warehouse, a gymnasium, or the like.

(Specific Example of Allocation System 200 (Part 5))

Next, a specific example of the allocation system 200 (part 5) is described. For example as the specific example of the allocation system 200 (part 5), the event is a plan of work by employee in a day, and the frame is a business hour frame of a day of the week, which is set in association with the day of the week so as to allocate the plan of work by employee thereto.

The case where the information processing device 100 is a different device from the terminal device 201 is described herein; however, the embodiment is not limited thereto. For example, there may be the case where the information processing device 100 is integral with the terminal device 201. In the following descriptions, the operations of the information processing device 100 are described using the above-described specific example of the allocation system 200 (part 1) as an example.

(Hardware Configuration Example of Information Processing Device 100)

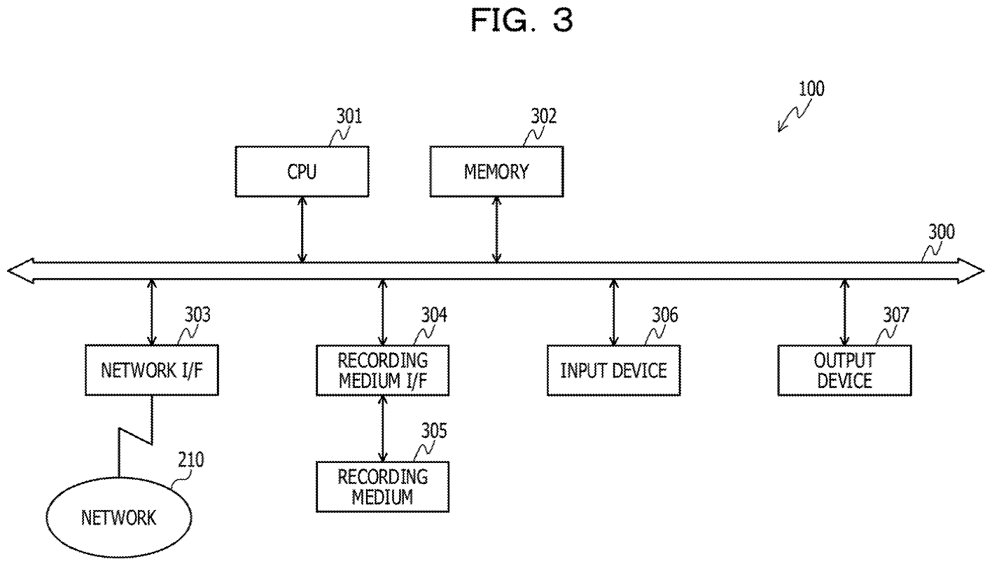

Next, a hardware configuration example of the information processing device 100 is described with reference to FIG. 3.

FIG. 3 is a block diagram illustrating the hardware configuration example of the information processing device 100. In FIG. 3, the information processing device 100 includes a central processing unit (CPU) 301, a memory 302, a network interface (I/F) 303, a recording medium I/F 304, a recording medium 305, an input device 306, and an output device 307. These components are coupled to one another through a bus 300.

The CPU 301 controls the entirety of the information processing device 100. The memory 302 includes, for example, a read-only memory (ROM), a random-access memory (RAM), a flash ROM, and the like. Specifically, for example, the flash ROM and the ROM store various programs, and the RAM is used as a work area of the CPU 301. The program stored in the memory 302 is loaded into the CPU 301, thereby causing the CPU 301 to execute coded processing.

The network I/F 303 is coupled to the network 210 through a communication line and is coupled to another computer via the network 210. The network I/F 303 controls the network 210 and an internal interface so as to control data input/output from/to the other computer. The network I/F 303 is, for example, a modem, a LAN adapter, or the like.

The recording medium I/F 304 controls reading/writing of data from/to the recording medium 305 under the control of the CPU 301. The recording medium I/F 304 is, for example, a disk drive, a solid state drive (SSD), a Universal Serial Bus (USB) port, or the like. The recording medium 305 is a nonvolatile memory that stores the data written under the control of the recording medium I/F 304. The recording medium 305 is, for example, a disk, a semiconductor memory, a USB memory, or the like. The recording medium 305 may be detachable from the information processing device 100.

The input device 306 is a device that inputs data. The input device 306 includes keys for inputting letters, numbers, various instructions, and the like to input data, for example. Specifically, the input device 306 is a keyboard, a mouse, or the like, for example. Specifically, the input device 306 may be a touch panel type-input pad, a numeric keypad, or the like, for example. Specifically, the input device 306 may be a microphone or the like, for example.

The output device 307 is a device that outputs data. The output device 307 is, for example, a display that displays not only a cursor, an icon, and a tool box but also data such as a document, an image, functional information, and so on. The display is, for example, a cathode ray tube (CRT), a liquid crystal display, an organic electroluminescence (EL) display, or the like. The output device 307 may be, for—example, a printer, a scanner, a speaker, or the like.

The information processing device 100 may not include the input device 306 and the output device 307. The information processing device 100 may include multiple recording medium I/Fs 304 or multiple recording media 305. The information processing device 100 may not include the recording medium I/F 304 or the recording medium 305.

(Contents Stored in Plan Database (DB) 400)

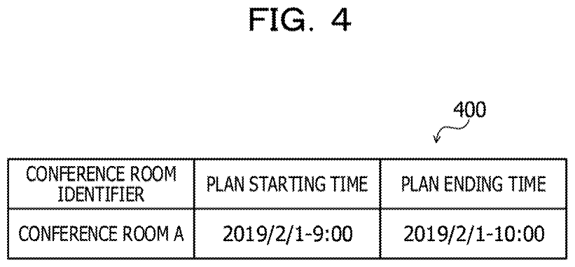

Next, an example of the contents stored in a plan DB 400 is described with reference to FIG. 4. The plan DB 400 is implemented by using, for example, a storage region such as the memory 302 or the recording medium 305 in the information processing device 100 illustrated in FIG. 3.

FIG. 4 is an explanatory diagram illustrating an example of the contents stored in the plan DB 400. As illustrated in FIG. 4, the plan DB 400 includes fields of a conference room identifier, a plan starting time, and a plan ending time. The plan DB 400 stores plan information as a record by setting information to each field for each plan to use a conference room.

A conference room identifier for identifying the conference room is set to the field of the conference room identifier. A plan starting time as a starting time of the plan to use the conference room is set to the field of the plan starting time. A plan ending time as an ending time of the plan to use the conference room is set to the field of the plan ending time. The plan DB 400 is able to indicate the time of the conference using the fields of the plan starting time and the plan ending time.

(Contents Stored in Request Frequency DB 500)

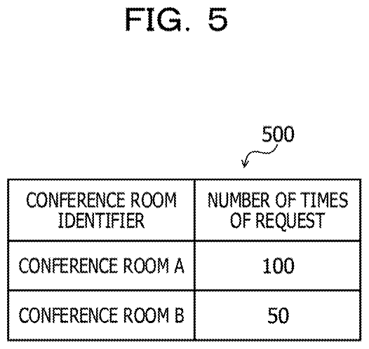

Next, an example of the contents stored in a request frequency DB 500 is described with reference to FIG. 5. The request frequency DB 500 is implemented by using, for example, a storage region such as the memory 302 or the recording medium 305 in the information processing device 100 illustrated in FIG. 3.

FIG. 5 is an explanatory diagram illustrating an example of the contents stored in the request frequency DB 500. As illustrated in FIG. 5, the request frequency DB 500 includes fields of the conference room identifier and the number of times of request. The request frequency DB 500 stores request frequency information as a record by setting information to each field for each conference room.

A conference room identifier for identifying the conference room is set to the field of the conference room identifier. The number of times of request that is the number of times that the conference room satisfied the condition for allocating the plan in the past is set to the field of the number of times of request.

(Contents Stored in Slot DB 600)

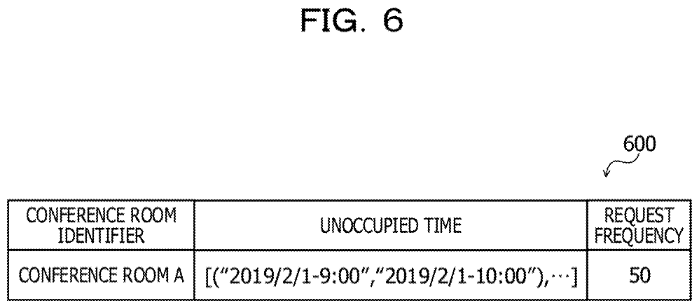

Next, an example of the contents stored, in a slot DB 600 is described with reference to FIG. 6. The slot DB 600 is implemented by using, for example, a storage region such as the memory 302 or the recording medium 305 in the information processing device 100 illustrated in FIG. 3.

FIG. 6 is an explanatory diagram illustrating an example of the contents stored in the slot DB 600. As illustrated in FIG. 6, the slot DB 600 includes fields of the conference room identifiers unoccupied time, and a request frequency. The slot DB 600 stores slot information as a record by setting information to each field for each slot.

The slot is a time frame set in association with each conference. room. The free space in the time frame as the slot is continuous and not separated into parts. When the free space in the time frame as the slot is separated into parts as a result of allocating the plan to the time frame as the slot, the slot is divided into two or more slots that each have a continuous free space.

A conference room identifier far identifying the conference room is set to the field of the conference room identifier. Information indicating the unoccupied time in the slot is set to the field of the unoccupied time. The information indicating the unoccupied time may indicate the unoccupied time in the slot indirectly by indicating the time period in the slot to which the plan is already allocated. The number of times of request that is the number of times that the conference room satisfied the condition for allocating the plan in the past is set to the field of the request frequency.

(Hardware Configuration Example of Terminal Device 201)

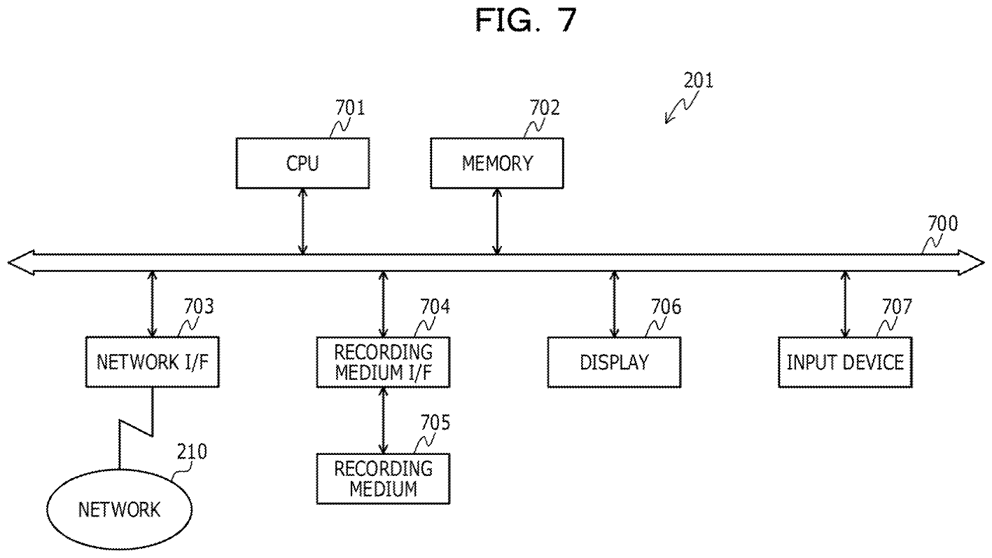

Next, a hardware configuration example of the terminal device 201 included in the allocation system 200 illustrated in FIG. 2 is, described with reference to FIG. 7.

FIG. 7 is a block diagram illustrating the hardware configuration example of the terminal device 201. In FIG. 7, the terminal device 201 includes a CPU 701, a memory 702, a network I/F 703, a recording medium I/F 704, a recording medium 705, a display 706, and an input device 707. These components are coupled to one another through a bus 700.

The CPU 701 controls the entirety of the terminal device 201. The memory 702 includes, for example, a ROM, a RAM, a flash ROM, and the like. Specifically, for example, the flash ROM and the ROM store various programs, and the RAM is used as a work area of the CPU 701. The program stored in the memory 702 is loaded into the CPU 701, thereby causing the CPU 701 to execute coded processing.

The network I/F 703 is coupled to the network 210 through a communication line and is coupled to another computer via the network 210. The network I/F 703 controls the network 210 and an internal interface so as to control data input/output from/to the other computer. The network I/F 703 is, for example, a modem, a LAN adapter, or the like.

The recording medium I/F 704 controls reading/writing of data from/to the recording medium 705 under the control of the CPU 701. The recording medium I/F 704 is, for example, a disk driver, an SSD, a USB port, or the like. The recording medium 705 is a nonvolatile memory that stores the data written under the control of the recording medium I/F 704. The recording medium 705 is, for example, a disk, a semiconductor memory, a USB memory, or the like. The recording medium 705 may be detachable from the terminal device 201.

The display 706 displays not only a cursor, an icon, and a tool box but also data such as a document, an image, functional information, and so on, The display 706 is, for example, a CRT, a liquid crystal display, an organic EL display, or the like. The input device 707 includes keys for inputting letters, numbers, various instructions, and the like to input data. The input device 707 may be a keyboard, a mouse, or the like, or may be a touch panel type-input pad, a numeric keypad, or the like.

In addition to the above-described components, the terminal device 201 may include, for example, a printer, a scanner, a microphone, a speaker, and the like. The terminal device 201 may include multiple recording medium I/Fs 704 or multiple recording media 705. The terminal device 201 may not include the recording medium I/F 704 and the recording medium 705.

(Functional Configuration Example of Information Processing Device 100)

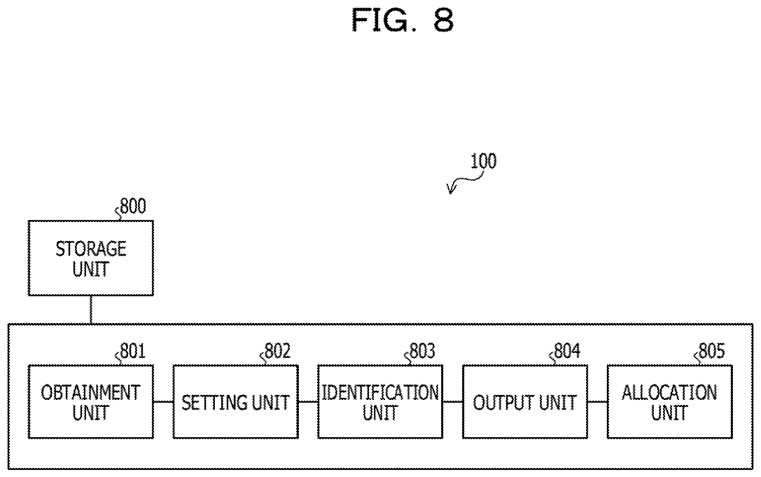

Next, a functional configuration example of the information processing device 100 is described with reference to FIG. 8.

FIG. 8 is a block diagram illustrating the functional configuration example of the information processing device 100. The information processing device 100 includes a storage unit 800, an obtainment unit 801, a setting unit 802, an identification unit 803, an output unit 804, and an allocation unit 805.

The storage unit 800 is implemented by using, for example, a storage region such as the memory 302 or the recording medium 305 illustrated in FIG. 3. The case where the storage unit 800 is included in the information processing device 100 is described below; however, the embodiment is not limited thereto. For example, there may be the case where the storage unit 800 is included in a different device from the information processing device 100, and the contents stored in the storage unit 800 are able to be referred through the information processing device 100.

The units of the information processing device 100 from the obtainment unit 801 to the output unit 804 function as an example of a control unit. Specifically, the functions of the units from the obtainment unit 801 to the output unit 804 are implemented by, for example, causing the CPU 301 to execute a program stored in the storage area such as the memory 302 or the recording medium 305 illustrated in FIG. 3, or by using the network I/F 303. Results of processing performed by the functional units are stored in a storage area such as the memory 302 or the recording medium 305 illustrated in FIG. 3, for example.

The storage unit 800 stores a variety of pieces of information to be referred to or updated in the processing of each functional unit. The storage unit 800 stores information on the plans set in each of the multiple frames. The frame is, for example, an available time frame of a conference room, which is set in association with the conference room. The event is, for example, a plan to use the conference room by a person. The storage unit 800 stores, for example, the plan DB 400 illustrated in FIG. 4.

There may be the case where the frame is, for example, a time frame of operation, and the event is, for example, a plan of a person working on the operation. There may be the case where the frame is a time frame in which an object is usable, and the event is a plan to use the object by a person. There may be the case where the frame is a time frame in which a service is available, and the event is a plan of providing a person with the service. There may be the case where the frame is a place usable by a person, and the event is a plan to use a part of the place by the person.

The storage unit 800 stores information on the usage frequency of each frame in the past. The storage unit 800 stores, for example, the request frequency DB 500 illustrated in FIG. 5. The storage unit 800 stores information indicating the frame. The information indicating the frame includes information indicating the free space in the frame and is, for example, the slot information illustrated in FIG. 6. The storage unit 800 stores, for example, the, slot DB 600 illustrated in FIG. 6.

The obtainment unit 801 obtains various types of information used for the processing of the functional units. The obtainment unit 801 stores the obtained various types of information in the storage unit 800 or outputs the obtained pieces of information to the functional units. The obtainment unit 801 may output the various types of information stored in advance in the storage unit 800 to the functional units. For example, the obtainment unit 801 obtains the various types of information based on an operational input by the user of the information processing device 100. For example, the obtainment unit 801 may receive the various types of information from a device different from the information processing device 100.

The obtainment unit 801 receives a demand for allocating a predetermined event to one of the multiple frames. For example, the demand includes information specifying the candidate for the frame to be the allocation space where to allocate a predetermined event. Specifically, the demand may include a condition for features of the conference room where to allocate the predetermined plan, for example. The features are, for example, the facilities and the capacity. Specifically, the demand may include a condition for a time period in the available time frame of a conference room where to allocate the predetermined plan, for example.

Specifically, the demand may include information designating the conference room where to allocate the predetermined plan, for example. When the candidate for the time frame to be the allocation space where to allocate the predetermined event is specified based on the information designating the conference room where to allocate the predetermined plan, not only the time frame of the designated conference room but also the time frame of another conference room having the same features as that of, the designated conference room may be identified. For example, the obtainment unit 801 receives the demand from the terminal device 201. For example, the obtainment unit 801 may receive the demand from the input device 306. The obtainment unit 801 thus makes it possible to specify the candidate for the frame where to allocate the predetermined event.

In response to the output of the candidate for the frame identified by the identification unit 803 to the terminal device 201, the obtainment unit 801 may receive an allocation instruction to permit the allocation of the predetermined event to the candidate for the frame identified by the identification unit 803. For example, the obtainment unit 801 receives the allocation instruction from the terminal device 201 in response to the output of the candidate identified by the identification unit 803 to the terminal device 201. For example, the obtainment unit 801 may receive the allocation instruction from the input device 306 in response to the output of the identified candidate from the output device 307. The obtainment unit 801 may be implemented by using a chatbot, a conversational robot, or the like.

The obtainment unit 801 is thus able to allocate the predetermined event to the candidate for the frame identified by the identification unit 803 after the permission by the user involved with the predetermined event. The obtainment unit 801 may receive a cancel notification to cancel the allocation of the predetermined event to the identified candidate.

The setting unit 802 sets the weight for the free space in each of one or more candidates for the frame to be the allocation space where to allocate the predetermined event. The weight is, for example, a correction factor that corrects the size of the free space. The free space is corrected to be greater as the weight is greater. Consequently, in the case of identifying as the allocation space a candidate that has a relatively small free space after the allocation of the predetermined event, the greater the weight set for the free space in the frame, the less likely it is to identify a candidate as the allocation space.

For example, the setting unit 802 specifies one or more candidates for the frame based on the information, which is included in the demand and specifies the candidate for the frame to be the allocation space where to allocate the predetermined event. For example, the setting unit 802 refers to the information on the usage frequency of each frame in the past and sets the weight for the free space in each of the identified one or more candidates based on the usage frequency of the candidate.

Specifically, the setting unit 802 specifies a candidate for the time frame to be the allocation space where to allocate the meeting plan among the available time frames of the multiple conference rooms and sets the weight for the free space in the candidate, for example. In this process, when the candidate for the time frame to be the allocation space is specified based on the information designating the conference room, the setting unit 802 may identify not only the time frame of the designated conference room but also the time frame of another conference room having the same features as that of the designated conference room.

The setting unit 802 is thus able to correct the size of the free space in the frame using the weight set for the free space and make the event more likely to be allocated to the frame as the usage frequency of the frame is lower. Additionally, the setting unit 802 is able to make a free space likely to be preserved, the free space being in a frame that has the relatively high usage frequency and is estimated to have the relatively high possibility that the allocation of another event thereto will be requested subsequently.

The setting unit 802 may set the weight for the free space in the candidate based on not only the usage frequency but also based on the features related to each of the one or more candidates for the frame to be the allocation space where to allocate the predetermined event. For example, the setting unit 802 may set the weight for the free space in each of the one or more candidates based on the usage frequency of each candidate identified based on the information included in the demand and the features of the conference room corresponding to each candidate. The features are, for example, the facilities, the capacity, and the like.

The setting unit 802 is thus able to make a free space likely to be preserved, the free space being in a frame that has the relatively high usage frequency and is estimated to have the relatively high possibility that the allocation of another event thereto will be requested subsequently because of the various facilities or the large capacity of the frame. The case where the setting unit 802 sets the weight based on the usage frequency and the features related to each candidate is described herein; however, the embodiment is not limited thereto. For example, there may be the case where the setting unit 802 does not use the usage frequency and sets the weight based on only the features related to each candidate.

The setting unit 802 may set the weight for the free space in each of the multiple frames in advance. Consequently, the setting unit 802 does not have to set the weight for the free space in each of the one or more candidates for the frame to be the allocation space where to allocate the predetermined event every time receiving the demand, and this makes it possible to reduce the amount of processing. When only one candidate for the frame to be the allocation space where to allocate the predetermined event is identified based on the information included in the demand, the setting, unit 802 may not set the weight. Consequently, the setting unit 802 is able to reduce the amount of processing.

The identification unit 803 identifies the allocation space where to allocate the predetermined event. For example, the identification unit 803 identifies as the allocation space a candidate that has a relatively small free space among the one or more candidates after the allocation of the predetermined event, based on the free space in each candidate and the weight for the free space. The candidate that has a relatively small free space is, for example, a candidate that has the smallest free space. The candidate that has a relatively small free space may be, for example, a candidate that has the second or further smallest free space.

Specifically, the identification unit 803 corrects the size of the free space of each candidate using the weight set for the free space, for example. Specifically, the identification unit 803 identifies a candidate that has a relatively small free space among the one or more candidates after the allocation of the predetermined event, based on the size of the free space after the correction, for example. The identification unit 803 is thus able to identify the allocation space for the predetermined event so as to easily avoid the situation where it is impossible to allocate another event subsequently to any of the frames.

When there is only one candidate for the frame to be the allocation space for the predetermined event, the identification unit 803 may identify this candidate as the allocation space for the predetermined event irrespective of the set weight. Thus, the identification unit 803 does not have to use the weight set for the free space to correct the size of the free space in the candidate, and this makes it possible to reduce the amount of processing.

The identification unit 803 may identify candidates for a frame as a selection target to be selected as the allocation space by the user involved with the predetermined event. For example, the identification unit 803 identifies as the candidates for the frame as the selection target a predetermined number of candidates among the one or more candidates based on the free space in each candidate and the weight for the free space, with the predetermined number of the candidates identified in order from the one that has the smallest free space after the allocation of the predetermined event. The identification unit 803 is thus able to give the discretion to the user to select the frame to be the allocation space, and this makes it possible to improve the convenience of the user.

When receiving the cancel notification of canceling the allocation of the predetermined event to the identified candidate as a result of the output of the identified candidate, the identification unit 803 may identify a candidate that has the next smaller free space than that of the previously identified candidate after the allocation of the predetermined event. The identification unit 803 is thus able to notify through the output unit 804 the user involved with the predetermined event of the one or more candidates one by one in ascending order of the size of the free space after the allocation of the predetermined event.

The output unit 804 outputs the candidate identified by the identification unit 803. The output is made by, for example, displaying on a display, outputting to a printer for printing, transmitting to an external device by the network I/F 303, and storing in a storage area such as the memory 302 or the recording medium 305. For example, the output unit 804 outputs the identified candidate to the terminal device 201. For example, the output unit 804 may output the identified candidate from the output device 307. The output unit 804 is thus able to allow the user involved with the predetermined event to grasp the candidate for the frame to be the allocation space for the predetermined event.

When the allocation unit 805 allocates the predetermined event to the allocation space, the output unit 804 outputs a notification indicating the completion of the allocation of the predetermined event to the allocation space to the terminal device 201. When the allocation unit 805 allocates the predetermined event to the allocation space, the output unit 804 may allow the output device 307 to output the notification indicating the completion of the allocation of the predetermined event. The output unit 804 may be implemented by using a chatbot, a conversational robot, or the like. The output unit 804 is thus able to notify the user involved with the predetermined event of the completion of the allocation of the predetermined event to the allocation space.

There may be the case where the output unit 804 outputs the candidates for the frame as the selection target. In this case, the obtainment unit 801 may receive the selected candidate for the frame. The output unit 804 may output the processing result of any of the functional unit. The output unit 804 is thus able to notify a manager of the information processing device 100 of the processing result of each functional unit, and this makes it possible to assist management and operation of the information processing device 100 including, for example, updating of setting values of the information processing device 100.

In response to the reception of the allocation instruction, the allocation unit 805 allocates the predetermined event to the identified candida In response to the reception of the selected candidate for the frame, the allocation unit 805 may allocate the predetermined event to the selected candidate for the frame. The allocation unit 805 is thus able to allocate the predetermined event so as to easily avoid the situation where it is impossible to allocate another event subsequently to any of the frames.

When the free space in one of the multiple frames becomes discontinuous as a result of allocating the event to the frame, the allocation unit 805 divides the frame into multiple frames each having a continuous free space. Consequently, even if the free space in the frame is separated into parts once, the allocation unit 805 is able to continue the processing.

(Specific Example of Functional Configuration of Information Processing Device 100)

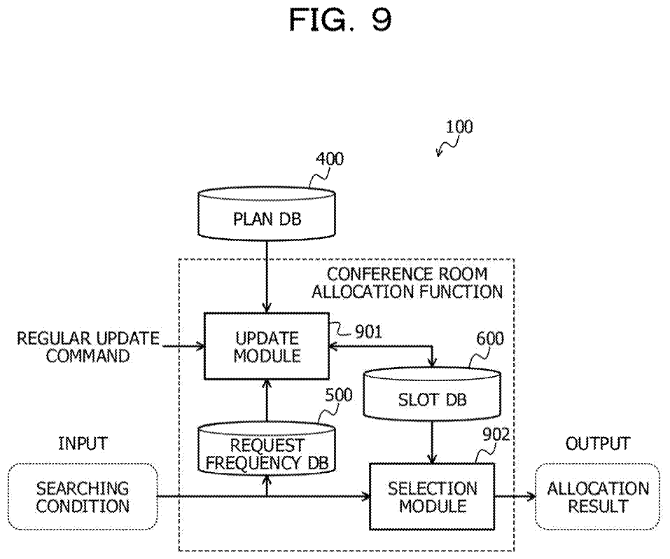

Next, a specific example of the functional configuration of the information processing device 100 is described with reference to FIG. 9.

FIG. 9 is a block diagram illustrating the specific example of the functional configuration of the information processing device 100. The information processing device 100 includes an update module 901 and a selection module 902. In FIG. 9, the information processing device 100 receives an input of a searching condition for identifying the slot of the conference room to be the allocation space where to allocate the conference plan from the user of the terminal device 201 through a conversation screen of a chatbot displayed and controlled for the terminal device 201. The user of the terminal device 201 may not be a user attending the conference.

The searching condition includes, for example, a condition related to the time of the conference. The condition related to the time of the conference includes, for example, the date and time of the conference, the time for conducting the conference, the time to be used for the conference, and the like. The condition related to the time of the conference is, specifically, “from 9:00 to 12:00 on Feb. 1, 2019”, or “from 9:00 on Feb. 1, 2019”+“(the time to be used is) one hour”, for example. The condition related to the time of the conference is, specifically, “this morning”, “tomorrow”, “next week”, or the like+“(the time to be used is) one hour” for example.

The searching condition includes, for example, a condition related to the conference room. The condition related to the conference room includes, for example, designation of the conference room or designation of the place of the conference room. The condition related to the conference room is, specifically, “conference room A on fifth floor of head-office building” designating only one conference room, or “fifth floor of head-office building” or “head-office building” designating multiple conference rooms, for example. The searching condition includes, for example, a condition related to the features of the conference room. The features are, for example, the facilities. The condition related to the features of the conference room is, specifically, the capacity such as “capacity of six people”, the equipment condition such as “projector is equipped” or “display is equipped”, or the features such as “private room” or “guest room”, for example.

When receiving the searching condition, the information processing device 100 searches for one or more conference rooms satisfying the searching condition. When receiving the searching condition including “conference room A on fifth floor of head-office building” designating only one conference room, the information processing device 100 may search for an alternative different conference room on the fifth floor of the head-office building as the conference room satisfying the searching condition. If there are one or more conference rooms satisfying the searching condition, the information processing device 100 updates the number of times of request corresponding to each of the one or more conference rooms satisfying the searching condition stored in the request frequency DB 500. The information processing device 100 uses the number of times of usage of the conference room as the usage frequency of the slot of the same conference room.

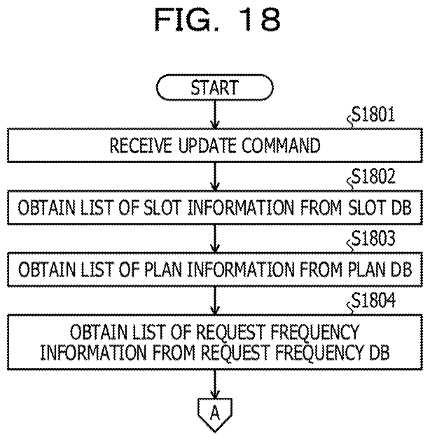

The update module 901 receives an update command regularly and updates the slot DB 600 with reference to the plan DB 400 and the request frequency DB 500. For example, when the update module 901 refers to the plan DB 400 and recognizes that a new plan is allocated to unoccupied, time indicated by the slot information in the slot DB 600, the update module 901 updates the unoccupied time based on the time of the new plan. When the update module 901 refers to the request frequency DB 500 and updates the unoccupied time of the slot information, the update module 901 updates the request frequency of the slot information. The operations of the update module 901 are implemented by update processing described later in FIG. 18, for example.

The selection module 902 refers to the slot DB 600 and selects a slot to be the allocation space where to allocate the conference plan among the slots of the one or more conference rooms satisfying the searching condition. For example, the selection module 902 corrects the length of the unoccupied time of each slot of one or more of the conference rooms satisfying the searching condition using the request frequency corresponding to the, slot and calculates the priority of the slot. The priority is 1/(length of unoccupied time x (request frequency+1)). For example, the selection module 902 selects a slot having the highest priority as the slot to be the allocation space where, to allocate the conference plan.

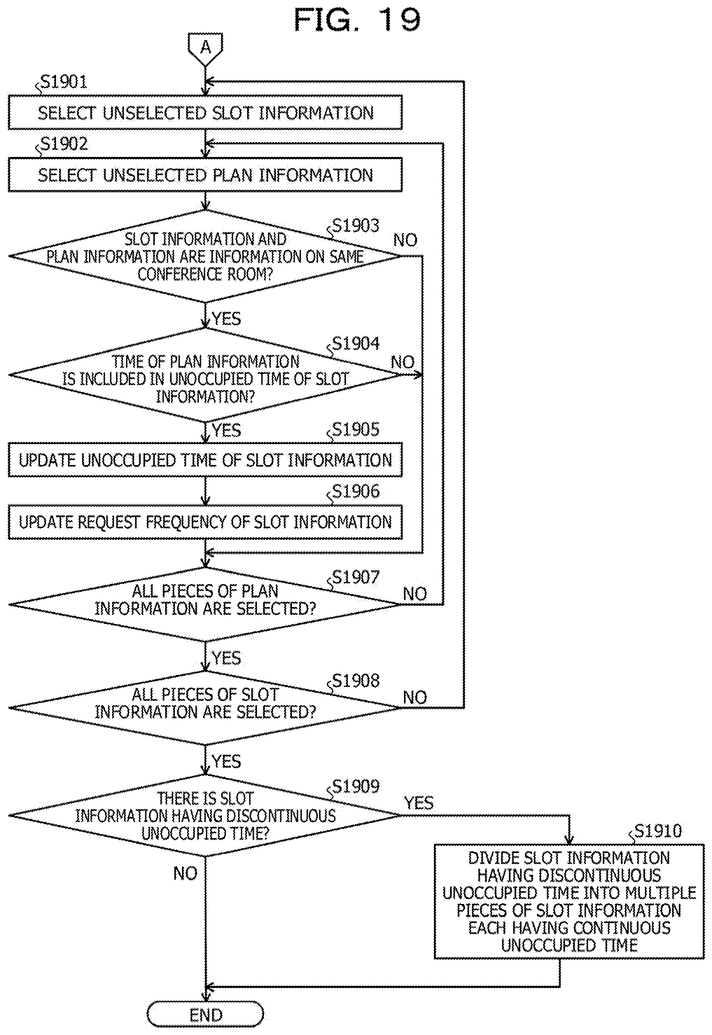

The selection module 902 notifies the user of the terminal device 201 of the selected slot through the conversation screen of the chatbot displayed and controlled for the terminal device 201. Once receiving the input of the allocation instruction through the conversation screen of the chatbot displayed and controlled for the terminal device 201, the selection module 902 allocates the conference plan to the selected slot. After allocating the conference plan to the selected slot, the selection module 902 updates the plan DB 400. The operations of the selection module 902 are implemented by allocation processing described later in FIG. 19, for example.

The case where the number of times of usage of the conference room is used as the usage frequency of the slot of the same conference room is described herein; however, the embodiment is not limited thereto. For example, there may be the case where the information processing device calculates the total sum of the whole number of times of usage of the multiple conference rooms in advance, and a value obtained by dividing the number of times of usage of the conference room by the total sum is used as the usage frequency of the slot of the same conference room.

The case where there are multiple slots for the same conference room, and the information processing device shares the number of times of usage of the conference room as the usage frequency of each slot is described herein; however, the embodiment is not limited thereto. For example, there may be the case where there are multiple slots for the same conference room, and the information processing device calculates the usage frequency by distributing the number of times of usage of the conference room to each slot.

(Operation Example of Information Processing Device 100)

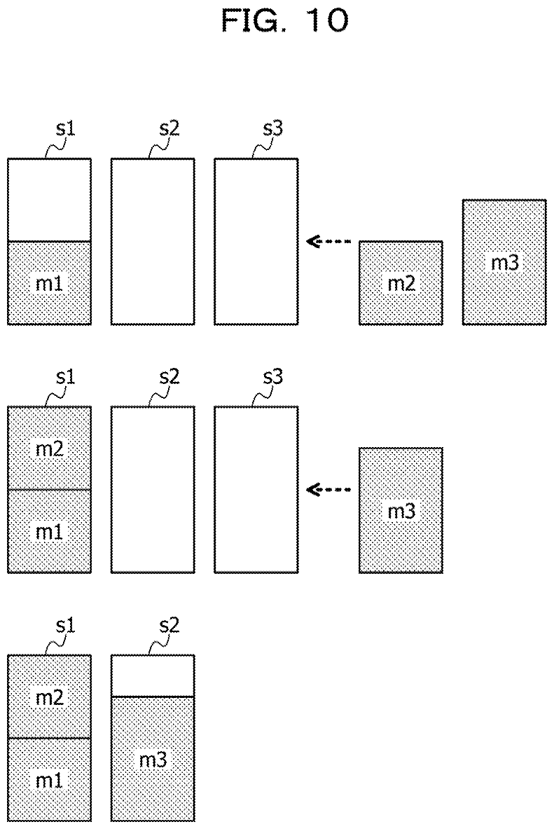

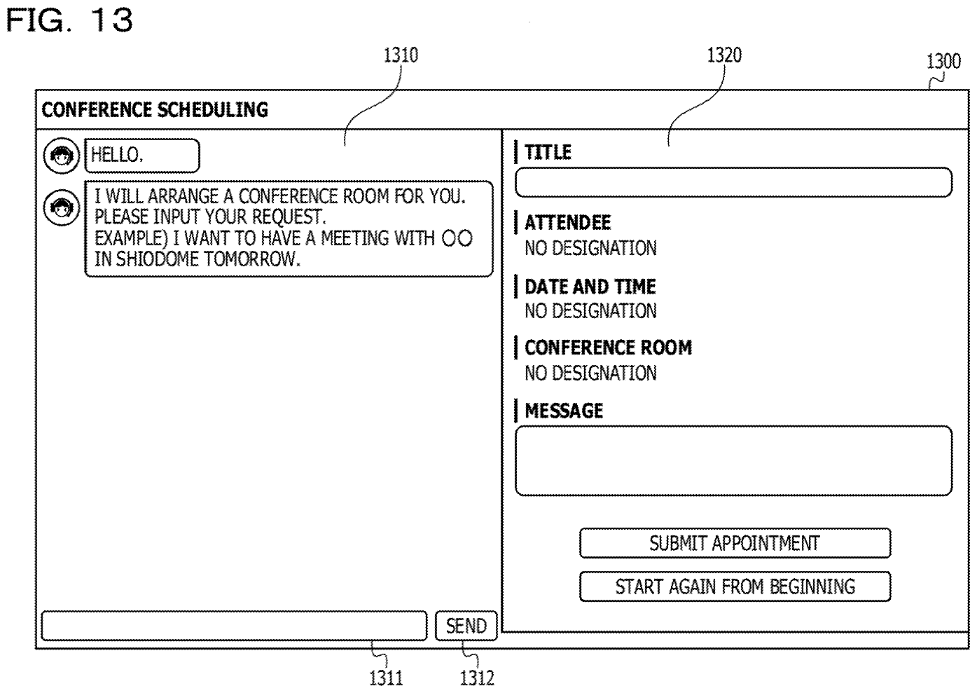

Next, an operation example of the information processing device 100 is described with reference to FIGS. 10 to 17. In the following description, an example where the meeting plan is allocated to one of the multiple slots is described with reference to FIGS. 10 to 12, and an example of the chatbot receiving the allocation demand is described with reference to FIGS. 13 to 17.

First, description continues with reference to FIG. 10, and an online algorithm for the bin packing problem used by the information processing device 100 during the allocation of the meeting plan to one of the multiple slots is described.

FIG. 10 is an explanatory diagram illustrating the online algorithm for the bin packing problem. The online algorithm is an algorithm for the case where various events are each allocated to the slots, for minimizing the number of the slots where to allocate the events by selecting a slot having the smallest free space as the allocation space. The above algorithm may refer to the following document for example.

B. Korte and J. Vygen, Combinatorial Optimization: Theory and Algorithms, 2nd ed., trans. Takao Asano (Maruzen Publishing, 2012)

In the example of FIG. 10, events m1 to m3 are allocated to slots s1 to s3, respectively. For example, according to the above algorithm, since the slots s1 to s3 have the same size of free spaces, it is determined that the event m1 may be allocated to any one of the slots s1 to s3, and the event m1 is allocated to the slot s1. Next, according to the above algorithm, since the free space of the slot s1 is relatively small, the event m2 is allocated to the slot s1 preferentially. Then, according to the above algorithm, since the slot s1 does not have the free space to which the event m3 is able to be allocated, and the slots s2 and s3 have the same size of free spaces, the event m3 is allocated to the slot s2.

In this way, the above algorithm minimizes the number of the slots to be the events are allocated. However, if the event m3 is able to be allocated to only the slot s1, the above algorithm makes it impossible to allocate the event m3 to the slot s1. For this reason, the information processing device 100 reduces the possibility that it is impossible to allocate the event to any of the slots while using the algorithm.

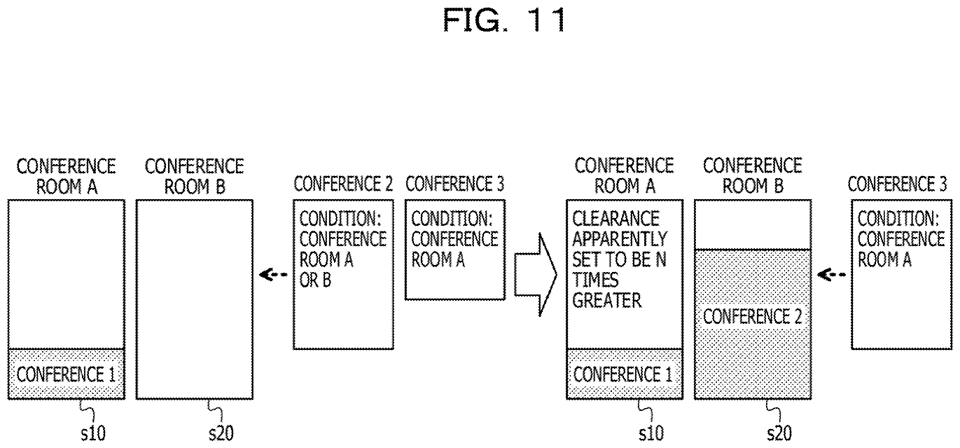

Next, description continues with reference to FIG. 11, and an example where the information processing device 100 allocates the meeting plan to one of the multiple slots while using the above algorithm is described. The slot indicates the available time frame of a conference room.

FIG. 11 is an explanatory diagram illustrating the example of allocating the meeting plan to one of the multiple slots. In the example of FIG. 11, there are a slot s10 of the conference room A and a slot s20 of the conference room B. The usage frequency of the conference room A is N, and the usage frequency of the conference room B is 1. The information processing device 100 allocates the plans of conferences 1 to 3 to the slot s10 of the conference room A and the slot s20 of the conference room B, sequentially.

For example, the information processing device 100 receives the allocation demand of the plan of the conference 1. The condition for setting the allocation space where to allocate the plan of the conference 1 is “conference room A”. The information processing device 100 allocates the plan of the conference 1 to the slot s10 of the conference room A. In this process when the time period where to allocate the plan of the conference 1 is not designated, the information processing device 100 preferably allocates the plan of the conference 1 such that the unoccupied time in the slot s10 of the conference room A is not separated into parts.

Next, for example, the information processing device 100 receives the allocation demand of the plan of the conference 2. The condition for setting the allocation space where to allocate the plan of the conference 2 is “conference room A or conference room B”. The information processing device 100 identifies the slot s10 of the conference room A and the slot s20 of the conference room B as the candidates for the allocation space where to allocate the plan of the conference.

For example, if the above algorithm is used without taking into consideration the usage frequency of the conference room A and the usage frequency of the conference room B, the plan of the conference 2 is allocated o the slot S10 of the conference room A having the relatively small unoccupied time. This consequently reduces the unoccupied time in the slot s10 of the conference room A that has the high usage frequency and is estimated to have the relatively high possibility that the allocation of another plan thereto will be requested subsequently, and the possibility that it is impossible to allocate the other plan subsequently is increased.

For this reason, the information processing device 100 corrects the size of the unoccupied time of the slot s10 of the conference room A to N times greater based on the usage frequency of the conference room A. Additionally, the information processing device 100 corrects the size of the unoccupied time of the slot s20 of the conference room B to 1 time greater based on the usage frequency of the conference room B. Thereafter, the information processing device 100 allocates the plan of the conference 2 to the slot s20 of the conference room B having the relatively small unoccupied time by using the above algorithm.

In this process, when the time period where to allocate the plan of the conference 2 is not designated, the information processing device 100 preferably allocates the plan of the conference 2 such that the unoccupied time in the slot s20 of the conference room B is not separated into parts. This allows the information processing device 100 to preserve the unoccupied time in the slot s10 of the conference room A that has the high usage frequency and is estimated to have the relatively high possibility that the allocation of another plan thereto will be requested subsequently.

Next, for example, the information processing device 100 receives the allocation demand of the plan of the conference 3. The condition for setting the allocation space where to allocate the plan of the conference 3 is “conference room A”. The information processing device 100 allocates the plan of the conference 3 to the slot s10 of the conference room A. In this process, when the time period where to allocate the plan of the conference 3 is not designated, the information processing device 100 preferably allocates the plan of the conference 3 such that the unoccupied time in the slot s10 of the conference room A is not separated into parts.

For example, if the plan of the conference 2 is allocated to the slot s10 of the conference room A in advance, it is impossible to allocate the plan of the conference 3 to the slot s10 of the conference room A, and there are no more slots of the conference rooms satisfying the condition. Therefore, the allocation fails. This may cause a user involved with the conference 3 to be at a disadvantage due to canceling of the plan of the conference 3 or to ask users involved with the conferences 1 and 2 for change of the allocation spaces for the plans of thee conferences 1 and 2, and consequently the work burden on the user may be increased.

In contrast, the information processing device 100 is able to make the allocation of the plan of the conference 3 likely to be succeeded, avoid the disadvantage of the user, and reduce the work burden on the user. Thus, the information processing device 100 is able to increase the number of the successful allocation of the plans for all the multiple slots and able to improve the work efficiency and work environment of the users involved with various conferences.

The case where the information processing device 100 corrects the size of the unoccupied time of the slot of the conference room using the usage frequency of the conference room as the weight is described herein; however, the embodiment is not limited thereto. For example, there may be the case where the information processing device 100 sets the weight for the unoccupied time of the slot of the conference room based on the usage frequency of the conference room and the features of the conference room.

The capacity of the conference room may be designated as the condition for setting the allocation space. The information processing device 100 sets the greater weight for the slot of the conference room according to the amount of the capacity of the conference room exceeding the designated capacity. This allows the information processing device 100 to preserve the unoccupied time in the slot of the conference room that has the large capacity and is estimated to have the high possibility that the allocation of another plan thereto will be requested subsequently.

Predetermined facilities of the conference room may not be set as the condition for setting the allocation space, and the predetermined facilities of the conference room may not be designated. The information processing device 100 makes the weight set for the slot of the conference room not provided with the predetermined facilities greater than the weight set for the slot of the conference room provided with the predetermined facilities.

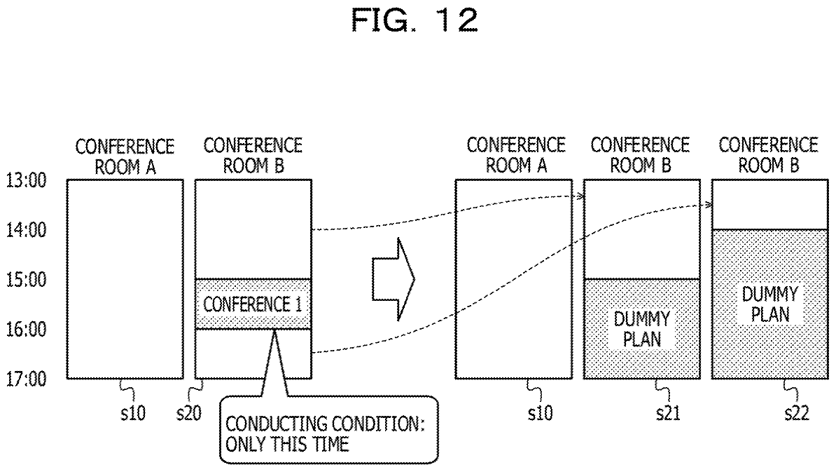

Consequently, the information processing device 100 is able to preserve the unoccupied time in the slot of the conference room that is provided with the predetermined facilities and versatile and is estimated to have the high possibility that the allocation of another plan thereto will be requested subsequently. Next, description continues with reference to FIG. 12, and an example where the information processing device 100 divides the slot of the conference room when the free space of the slot is separated into parts as a result of the allocation of the conference plan is described.

FIG. 12 is an explanatory diagram illustrating the example of dividing a slot. In FIG. 12, since the time period where to allocate the plan of the conference 1 is designated, the information processing device 100 allocates the plan of the conference 1 to the time period such that the unoccupied time in the slot s20 of the conference room B is separated into parts. In this case, the information processing device 100 divides the slot s20 of the conference room B into a slot s21 and a slot s22 of the conference room B each having corresponding one of the divided two free spaces. The sizes of the divided slots s21 and s22 are not changed from the sizes thereof in the slot s20 before the division, and dummy plans are allocated to the slots s21 and s22, respectively. The information processing device 100 is thus able to generate the slots so that the above algorithm is applicable even after the separation of the free space.

(Example of Screen Implementing Chatbot)

Next, an example of a screen implementing the chatbot is described with reference to FIGS. 13 to 15.

FIGS. 13 to 15 are explanatory diagrams illustrating the example of the screen implementing the chatbot. In FIG. 13, the information processing device 100 displays a browser screen 1300 implementing the chatbot by performing display control of the terminal device 201.

For example, the browser screen 1300 includes a conversation display area 1310 displaying a message from the information processing device 100 and a message inputted by the user of the terminal device 201. For example, the conversation display area 1310 includes an input column 1311 to which the user of the terminal device 201 inputs the message and a transmission button 1312 for determining the inputted message and transmitting the message to the information, processing device 100.

The browser screen 1300 includes a plan display area 1320 displaying the result of the allocation of the conference plan through the chatbot.

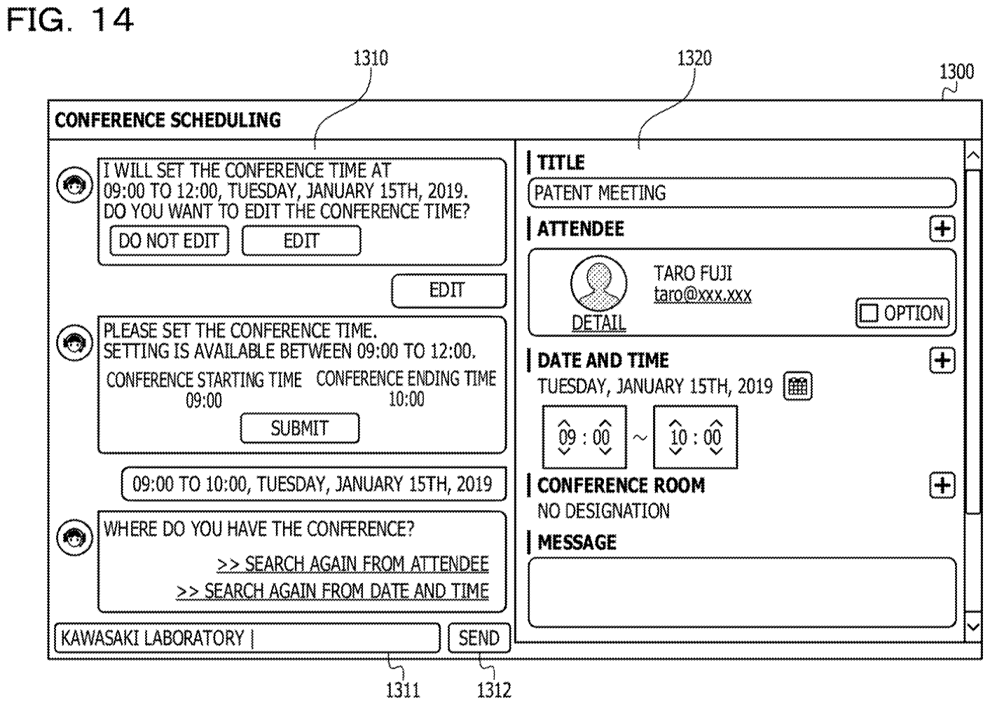

In the example of FIG. 13, the information processing device 100 displays a message prompting an input of the condition for allocating the conference plan in the conversation display area 1310 and waits for the input of the condition for allocating the conference plan. Next, description continues with reference to FIG. 14.

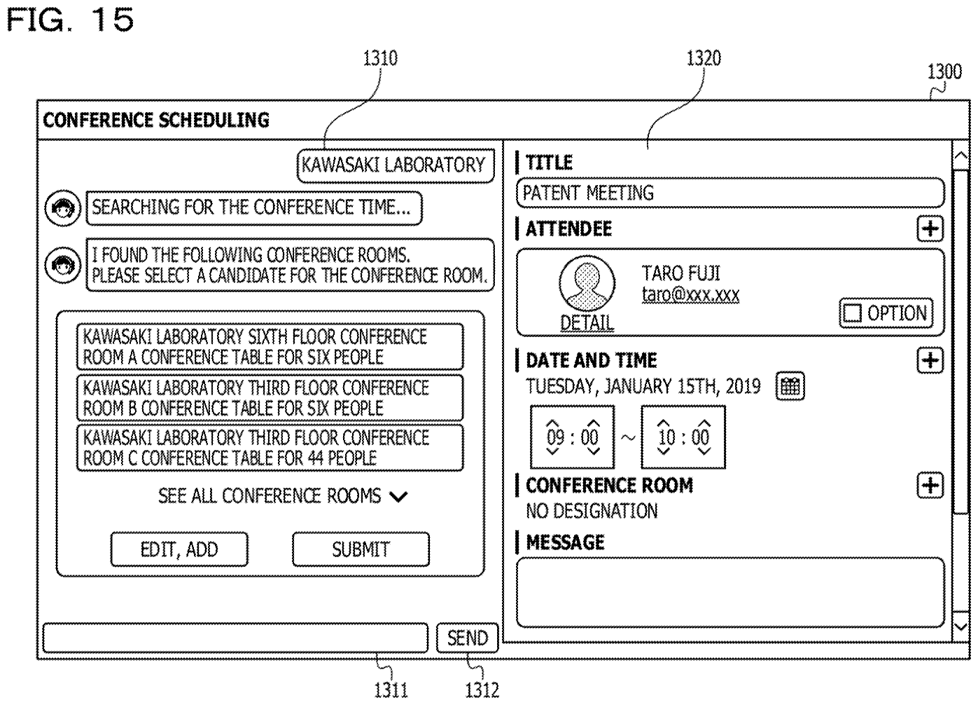

In the example of FIG. 14, the user of the terminal device 201 inputs the condition related to the time of the conference to the input column 1311 and clicks the transmission button 1312. In response to the click of the transmission button 1312, the information processing device 100 receives the condition related to the time of the conference from the terminal device 201. The user of the terminal device 201 inputs the condition related to the place of the conference to the input column 1311 and clicks the transmission button 1312. In response to the click of the transmission button 1312, the information processing device 100 receives the condition related to the place of the conference from the terminal device 201. Next, description continues with reference to FIG. 15.

In the example of FIG. 15, like FIG. 11, the information processing device 100 calculates the priority of the slot of each of the multiple conference rooms based on the received various conditions, identifies the slot to be the allocation space where to allocate the conference plan, and displays the identified slot in the conversation display area 1310. For example, the information processing device 100 may identify only the slot having the highest priority as the slot to be the allocation space and display the identified slot in the conversation display area 1310.

For example, the information processing device 100 may identify the slots sequentially in order from the one having the relatively high priority and display the, identified slot in the conversation display area 1310. Specifically, when one of the slots is displayed and then the allocation of the conference plan to the slot is canceled by the user of the terminal device 201, the information processing device 100 identifies and displays a slot having the next highest priority following the canceled slot and repeats this process.

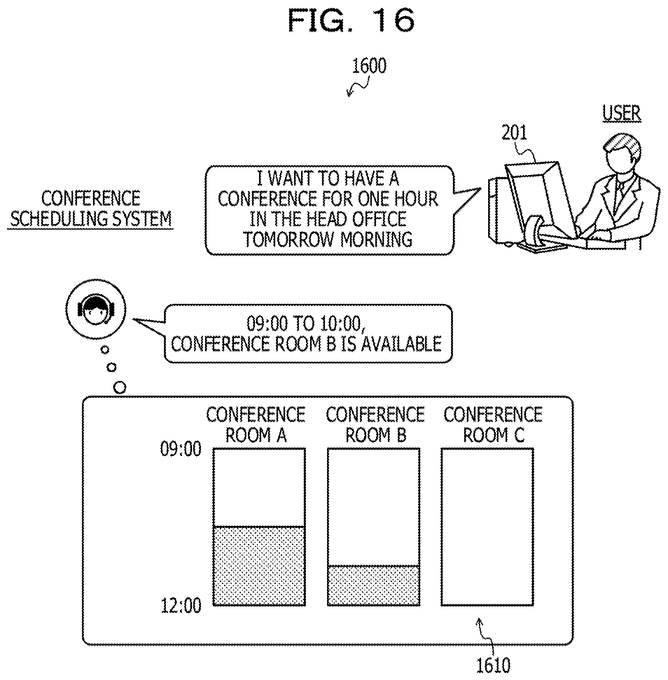

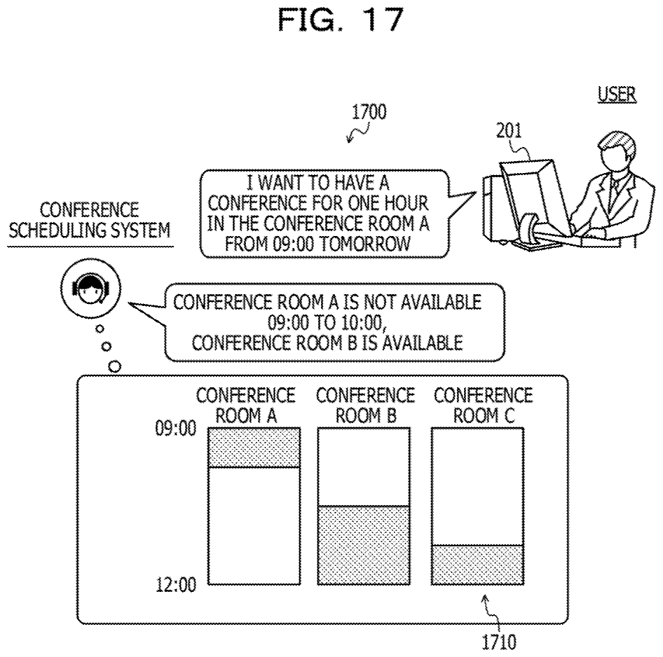

For example, the information processing device 100 may identify multiple slots, from the one having the highest priority to the following one having a predetermined level of priority, as the candidates for the slot to be the allocation space and display the identified slots in the conversation display area 1310. In the example of FIG. 15, the information processing device 100 identifies the slots, from the one having the highest priority to the following one having the third highest priority, displays the identified slots in the conversation display area 1310, and waits for the user of the terminal device 201 to select one of the slots. When the user of the terminal device 201 selects one of the slots, the information processing device 100 allocates the conference plan to the selected slot. The information processing device 100 displays the information on the allocated conference plan in the plan display area 1320. Next, description continues with reference to FIGS. 16 and 17, and another example of the conversation with the user in the chatbot is described.

FIGS. 16 and 17 are explanatory diagrams illustrating the other example of the conversation with the user in the chatbot. In the example of FIG. 16, the user of the terminal device 201 inputs a message “I want to have a conference for one hour in the head office tomorrow morning” through a browser screen 1600. In response, the information processing device 100 extracts the searching condition from the message “I want to have a conference for one hour in the head office tomorrow morning”.

The information processing device 100 takes into consideration a current allocation state 1610 and the usage frequencies of the conference rooms A, B, and C and identifies only one slot to be the allocation space for the conference plan even when there are multiple slots satisfying the searching condition. In the example of FIG. 16, the information processing device 100 identifies the slot of the conference room B as the allocation space for the conference plan. The information processing device 100 then outputs a message “09:00-10:00, the conference room B is available” through the browser screen 1600.

Thus, when there are multiple slots satisfying the searching condition, the information processing device 100 is able to allocate the conference plan of this time to one of the slots satisfying the searching condition that has the relatively low usage frequency and is estimated that the allocation of another conference plan thereto is not likely to be requested subsequently. Consequently, the information processing device 100 is able to preserve the free space in the slot estimated to have the relatively high possibility that the allocation of another event thereto will be requested subsequently, so as to allow the subsequent allocation of the other conference plan thereto, every time the conference plan is allocated to one of the slots. Next, description continues with reference to FIG. 17.

In the example of FIG. 17, the user of the terminal device 201 inputs a message “I want to have a conference for one hour in the conference room A from 09:00 tomorrow” through a browser screen 1700. In response, the information processing device 100 extracts the searching condition from the message “I want to have a conference for one hour in the conference room A from 09:00 tomorrow”. Although the message designates “only the conference room A”, the information processing device 100 may treat the searching condition as a condition designating also another conference room alternative to the conference room A and may extract the other conference room as well.

Since there is no unoccupied time from 09:00 in the slot of the conference room A, the information processing device 100 takes into consideration a current allocation state 1710 and the usage frequencies of the conference rooms A, B, and C and identifies the slot of the conference room B, which is different from the conference room A but alternative thereto. In the example of FIG. 17, the information processing device 100 outputs a message “The conference room A is not available, 09:00-10:00, the conference room B is available” through the browser screen 1700.

The information processing device 100 is thus able to allocate the conference plan of this time to the slot of the conference room B, which is different from the conference room A but alternative thereto, without changing the conference plan already allocated to the slot of the conference room A. The information processing device 100 is able to suggest the conference room B, which is different from the conference room A but alternative thereto, to the user involved with the conference of this time and suppress the occurrence of disadvantage. The information processing device 100 is able to complete the new allocation without changing the conference plan already allocated to the slot of the conference room A and avoid the increase of the work burden on the user involved with the conference already allocated to the slot of the conference room A.

The information processing device 100 is able to identify the allocation space for the conference plan of this time while taking into consideration the situation where the allocation of another conference plan will be requested subsequently, in the timing of allocating the conference plan. The information processing device 100 is thus able to reduce the possibility that the conference plan has to be changed after once the conference plan is allocated. Consequently, the information processing device 100 is able to reduce the possibility that the conference plan has to be changed by the user who once allocates the conference plan, and this makes it possible to reduce the work burden.

(Update Processing Procedure)

Next, an example of an update processing procedure to be executed by the information processing device 100 is described with reference to FIGS. 18 and 19. The update processing is implemented by, for example, the CPU 301, the storage area such as the memory 302 or the recording medium 305, and the network I/F 303 illustrated in FIG. 3.

FIGS. 18 and 19 are flowcharts illustrating the example of the update processing procedure. In FIG. 18, the information processing device 100 receives the update command (step S1801). Then, once receiving the update command, the information processing device 100 obtains a of the slot information from the slot DB 600 (step S1802).

Next, the information processing device 100 obtains a list of the plan information from the plan DB 400 (step S1803). The information processing device 100 then obtains a list of the request frequency information from the request frequency DB 500 (step S1804). The information processing device 100 proceeds to the processing of step S2001 in FIG. 19.

In FIG. 19, the information processing device 100 selects unselected slot information from the list of the slot information (step S1901). The information processing device 100 then selects unselected plan information from the list of the plan information (step S1902).

Next, the information processing device 100 determines whether the selected slot information and the selected plan information are information on the same conference room (step S1903). When the pieces of information are the information on the same conference room (step S1903: Yes), the information processing device 100 proceeds to the processing of step S1904. On the other hand, when the pieces of information are not the information on the same conference room (step S1903: No), the information processing device 100 proceeds to the processing of step S1907.

In step S1904, the information processing device 100 determines whether the time of the selected plan information is included in the unoccupied time of the selected slot information (step S1904). When the time is included in the unoccupied time (step S1904: Yes), the information processing device 100 proceeds to the processing of step S1905. On the other hand, when the time is not included in the unoccupied time (step S1904: No), the information processing device 100 proceeds to the processing of step S1907.

In step S1905, the information processing device 100 updates unoccupied time of the selected slot information (step S1905). Next, the information processing device 100 updates the request frequency of the selected slot information (step S1906). Then, the information processing device 100 proceeds to the processing of step S1907.

In step S1907, the information processing device 100 determines whether all pieces of the plan information are selected (step S1907). When there is unselected plan information (step S1907: No), the information processing device 100 returns to the processing of step S1902. On the other hand, when all pieces of the plan information are selected (step S1907: Yes), the information processing device 100 proceeds to the processing of step S1908.

In step S1908, the information processing device 100 determines whether all pieces of the slot information are selected (step S1908). When there is unselected slot information (step S1908: No), the information processing device 100 returns to the processing of step S1901. On the other hand, when all pieces of the slot information are selected (step S1908: Yes), the information processing device 100 proceeds to the processing of step S1909.

In step S1909, the information processing device 100 determines whether there is slot information having discontinuous unoccupied time (step S1909). When there is no slot information having discontinuous unoccupied time (step S1909: No), the information processing device 100 terminates the update processing. On the other hand, when there is the slot information having discontinuous unoccupied time (step S1909: Yes), the information processing device 100 proceeds to the processing of step S1910.

In step S1910, the information processing device 100 divides the slot information having discontinuous unoccupied time into multiple pieces of slot information each having continuous unoccupied time (step S1910). The conference room identifier and the request frequency of the slot information before division are used as the conference room identifier and the request frequency of the slot information after division. Then, the information processing device 100 terminates the update processing. The information processing device 100 is thus able to update the slot information and make the slot information usable for the allocation processing.

(Allocation Processing Procedure)

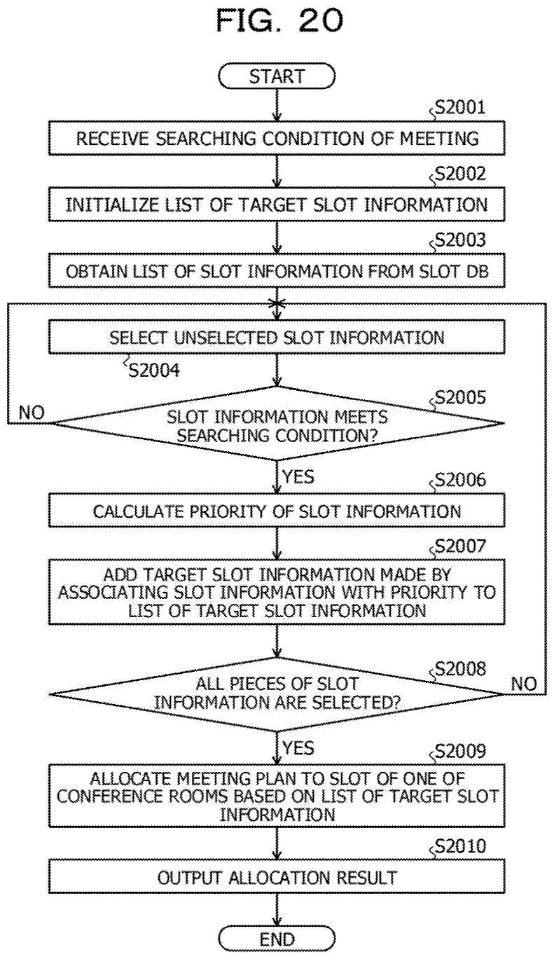

Next, an example of an allocation processing Procedure executed by the information processing device 100 is described with reference to FIG. 20. The allocation processing is implemented by, for example, the CPU 301, the storage area such as the memory 302 or the recording medium 305, and the network I/F 303 illustrated in FIG. 3.

FIG. 20 is a flowchart illustrating an example of an allocation processing procedure. In FIG. 20, the information processing device 100 receives the searching condition of the meeting (step S2001). The searching condition includes, for example, the condition of the conference room and the condition of the time. The information processing device 100 then initializes a list of target slot information (step S2002).

Next, the information processing device 100 obtains the list of the slot information from the slot DB 600 (step S2003). The information processing device 100 then selects unselected slot information from the list of the slot information (step S2004).

Next, the information processing device 100 determines whether the selected slot information meets the searching condition (step S2005). For example, the information processing device 100 determines that the selected slot information meets the searching condition when the conference room indicated by the selected slot information satisfies the condition of the conference room included in the searching condition and the unoccupied time indicated by the selected slot information satisfies the condition of the time included in the searching condition. When the selected slot information does not meet the searching condition (step S2005: No), the information processing device 100 returns to the processing of step S2004. On the other hand, when the selected slot information meets the searching condition (step S2005: Yes), the information processing device 100 proceeds to the processing of step S2006.

In step S2006, the information processing device 100 calculates the priority of the selected slot information (step S2004 The priority is 1/(length of unoccupied time×(request frequency+1)). Next, the information processing device 100 adds target slot information made by associating the selected slot information with the priority to the list of the target slot information (step S2007).

The information processing device 100 then determines whether all pieces of the slot information are selected (step S2008). When there is unselected slot information (step S2008: No), the information processing device 100 returns to the processing of step S2004. On the other hand, when all pieces of the slot information are selected (step S2008: Yes), the information processing device 100 proceeds to the processing of step S2009.

In step S2009, the information processing device 100 allocates the meeting plan to the slot of one of the conference rooms based on the list of the target slot information (step S2009). For example, the information processing device 100 identifies the slot of the conference room indicated by the slot information having the highest priority as the allocation space for the meeting plan and allocates the meeting plan to the identified slot. When the list of the target slot information is blank, the information processing device 100 determines that the allocation fails.

Next, the information processing device 100 outputs the allocation result (step S2010). Then, the information processing device 100 terminates the allocation processing. The information processing device 100 is thus able to sequentially allocate the various meeting plans to the slots so as to reduce the possibility that it is impossible to allocate a meeting plan to any of the slots.

The information processing device 100 may change the order o the processing in some steps in each flowchart illustrated in FIGS. 18 to For example, the order of the processing in steps S1905 and S1906 is interchangeable.

As described above, according to the information processing device 100, it is possible to receive a demand for allocating a predetermined event to one of multiple frames. According to the information processing device 100, it is possible to set a weight for a free space in each of one or more candidates identified based on information in the demand identifying a candidate for a frame where to allocate the predetermined event, based on a usage frequency of the candidate. According to the information processing device 100, it is possible to identify, from among the one or more candidates, a candidate that has a relatively small free space after allocation of the predetermined event based on the free spaces in the candidates and the weights for the free spaces, and output the identified candidate.

The information processing device 100 is thus able to preserve the free space in the frame estimated to have the relatively high possibility that the allocation of another event thereto will be requested subsequently, every time an event is allocated to one of the frames, so as to allow the subsequent allocation of the other event thereto.

According to the information processing device 100, it is possible to identify the candidate that has the smallest free space among the one or more candidates after allocation of the predetermined event based on the free spaces in the candidates and the weights for the free spaces. The information processing device 100 is thus able to allocate the predetermined event to a free space in the frame estimated to have the lowest possibility that the allocation of another event thereto will be requested. Consequently, the information processing device 100 is able to increase the possibility that it is possible to allocate the other event to any one of the frames subsequently.

According to the information processing device 100, it is possible to correct the size of the free space of each candidate using the weight set for the free spaces According to the information processing device 100, it is possible to identify, from among the one or more candidates, a candidate that has a relatively small free space after allocation of the predetermined event based on the corrected sizes of the free spaces. Thus, when the online algorithm for the bin packing problem is used, the information processing device 100 is able to preserve a free space in the frame estimated to have the relatively high possibility that the allocation of another event thereto will be requested subsequently.

According to the information processing device 100, when a free space in one of the multiple frames becomes discontinuous as a result of allocating an event to the frame, it is possible to divide the frame into multiple frames each having a continuous free space. The information processing device 100 is thus able to make the online algorithm for the bin packing problem usable even after a free space in one of the frames becomes discontinuous.

According to the information processing device 100, it is possible to use an available time frame of a conference room as the frame, and it is possible to use a plan to use the conference room by a person as the event. The information processing'device 100 is thus able to allocate the plan to use the conference room by the person to the available time frame of the conference room.

According to the information processing device 100, it is possible to set the weight for the free space in each of the one or more candidates based on the usage frequency of each candidate and facilities of a conference room corresponding to each candidate. The information processing device 100 is thus able to take into consideration the facilities of the conference rooms and preserve a free space in the frame that has various facilities and is estimated to have the relatively high possibility that the allocation of another event thereto will be requested subsequently.

According to the information processing device 100, it is possible to receive the demand from the terminal device 201 and output the identified candidate to the terminal device 201. According to the information processing device 100, it is possible to receive an allocation instruction from the terminal device 201 in response to the output of the identified candidate to the terminal device 201. According to the information processing device 100, it is possible to allocate the predetermined event to the identified candidate and output a notification indicating completion of the allocation of the predetermined event to the identified candidate to the terminal device 201, in response to the reception of the allocation instruction. The information processing device 100 is thus able to implement a chatbot and receive or output the various pieces of information between the terminal device 201.

According to the information processing device 100, it is possible to receive the demand including the information from an, input device. According to the information processing device 100, it is possible to output the identified candidate from an output device. According to the information processing device 100, it is possible to receive the allocation instruction from the input device in response to the output of the identified candidate from the output, device.

According to the information processing device 100, it is possible to allocate the predetermined event to the identified candidate and output the notification indicating completion of the allocation of the predetermined event to the identified candidate from the output device, in response to the reception of the allocation instruction. The information processing device 100 is thus able to implement the chatbot and receive or output the various pieces of information within the information processing device 100 itself.

According to the information processing device 100, when receiving a notification of canceling the allocation of the predetermined event to the identified candidate as a result of the output of the identified candidate, it is possible to identify a candidate that has the next smaller free space than that of the previously identified candidate after the allocation of the predetermined event and output the identified candidate. The information processing device 100 is thus able to give the discretion to a user involved with the predetermined event to select the allocation space, improve the convenience, and make it easier to preserve the free space in the frame estimated to have the relatively high possibility that the allocation of another event thereto will be requested subsequently.

According to the information processing device 100 it is possible to use a time frame of operation as the frame, and it is possible to use a plan of a person working on the operation as the event. The information processing device 100 is thus able to allocate the plan of the person working on the operation to the time frame of the operation.

According to the information processing device 100, it is possible to use a time frame in which an object is usable as the frame, and it is possible to use a plan to use the object by a person as the event. The information processing device 100 is thus able to allocate the plan to use the object by the person to the time frame in which the object is usable.

According to the information processing device 100, it is possible to use a time frame in which a service is available as the frame, and it is possible to use a plan of providing a person with the service as the event. The information processing device 100 is thus able to allocate the plan of providing the person with the service to the time frame in which the service is available.

According to the information processing device 100, it is possible to use a place usable by a person as the frame, and it is possible to use a plan to use a part of the place by the person as the event. The information processing device 100 is thus able to allocate the plan to use a part of the place by the person to the place usable by the person.

The allocation method described according to the present embodiment is able to be implemented by causing a computer such as a personal computer or a workstation to execute a prepared program. The allocation program described according to the present embodiment is recorded on a computer-readable recording medium such as a hard disk, a flexible disk, a compact disc (CD)-ROM, a magneto-optical (MO) disc, or a digital versatile disc (DVD) and is executed as a result of being read from the recording medium by the computer. The allocation program described according to the present embodiment may be distributed through a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An allocation method executed by a computer, the allocation method comprising:
receiving a demand for allocating a predetermined event to one of plurality of frames;
setting a weight for a free space in each of a plurality of candidates based on usage frequency of one or more candidates corresponding to the demand for allocating the predetermined event by referring to information on usage frequency of each of a plurality of frames in the past;
identifying, from among the plurality of candidates, a candidate whose space is smaller than another space when allocating the predetermined event to the candidate based on the free space in each of the plurality of candidates and the weight for the free space; and
outputting the identified candidate.

2. The allocation method according to claim 1, wherein
the identifying includes
identifying the candidate that has the smallest free space from among the plurality of candidates when allocating the predetermined event to the candidate based on free spaces in the candidates and weights for the free spaces.

3. The allocation method according to claim 1, wherein the identifying includes:
correcting a size of the free space in each candidate using the weight set for the free space; and
identifying, from among the plurality of candidates, a candidate whose space is smaller than another space after allocating the predetermined event to the candidate based on the corrected sizes of free spaces.

4. The allocation method according to claim 1, wherein the allocation method further comprising
dividing the frame into a plurality of frames each having a continuous free space when the free space in one of the plurality of frames becomes discontinuous as a result of allocating an event to the frame.

5. The allocation method according to claim 1, wherein
the frame is an available time frame of a conference room, and
the event is a plan to use the conference room by a person.

6. The allocation method according to claim 5, wherein
the demand includes a condition for facilities of a conference room where to allocate a predetermined plan, and
the setting includes
setting the weight for the free space in each of the plurality of candidates identified based on the information in the demand, based on the usage frequency of the candidate and the facilities of the conference room corresponding to the candidate by referring to the information on the usage frequencies of the time frames in the past.

7. The allocation method according to claim 1, wherein
the receiving includes receiving the demand including the information from a terminal device; and
the outputting includes outputting the identified candidate to the terminal device.

8. The allocation method according to claim 7, further comprising:
receiving an allocation instruction from the terminal device in response to the output of the identified candidate to the terminal device; and
allocating the predetermined event to the identified candidate and outputting a notification to indicate completion of the allocation of the predetermined event to the identified candidate to the terminal device in response to the reception of the allocation instruction.

9. A non-transitory computer-readable storage medium storing a program that causes a computer to execute a process, the process comprising:
receiving a demand for allocating a predetermined event to one of a plurality of frames;
setting a weight for free space in each of a plurality of candidates based on usage frequency of one or more candidates corresponding to the demand for allocating the predetermined event by referring to information on usage frequency of each of a plurality of frames in the past;
identifying, from among the plurality of candidates, a candidate whose space is a smaller than another space when allocating the predetermined event to the candidate based on the free space in each of the candidates and the weights for the free space; and
outputting the identified candidate.

10. An information processing device, comprising:
a memory; and
a processor coupled to the memory and configured to:
receive a demand for allocating a predetermined event to one of a plurality of frames,
set a weight for a free space in each of a plurality of candidates based on usage frequency of one or more candidates corresponding to the demand for allocating the predetermined event by referring to information on usage frequency of each of a plurality of frames in the past;
identify, from among the plurality of candidates, a candidate whose space is a smaller than another space when allocating the predetermined event to the candidate based on the free space in each of the candidates and the weights for the free space; and
output the identified candidate.

11. The information processing device, according to claim 10, wherein the processor is configured to:
identify the candidate that has the smallest free space from among the plurality of candidates when allocating the predetermined event to the candidate based on free spaces in the candidates and weights for the free spaces.

12. The information processing device, according to claim 10, wherein the processor is configured to:
correct a size of the free space in each candidate using the weight set for the free space, and
identify, from among the plurality of candidates, a candidate whose space is smaller than another space after allocating the predetermined event to the candidate based on the corrected sizes of free spaces.

13. The information processing device, according to claim 18, wherein the processor is configured to:
divide the frame into a plurality of frames each having a continuous free space when the free space in one of the plurality of frames becomes discontinuous as a result of allocating an event to the frame.

14. The information processing device, according to claim 10, wherein
the frame is an available time frame of a conference room, and
the event is a plan to use the conference room by a person.

15. The information processing device, according to claim 10, wherein
the demand include a condition for facilities of a conference room where to allocate a predetermined plan, and
the processor is configured to:
set the weight for the free space in each of the plurality of candidates identified based on the information in the demand, based on the usage frequency of the candidate and the facilities of the conference room corresponding to the candidate by referring to the information on the usage frequencies of the time frames in the past.
